(19) United States
(12) Patent Application Publication
(10) Pub. No.: US 2008/0189217 A1
(43) Pub. Date: Aug. 7, 2008

(54) Estimating Values of Assets

(76) Inventor: Manish Jhunjhunwala, Boston, MA (US)

Correspondence Address: FISH & RICHARDSON PC, P.O. BOX 1022, MINNEAPOLIS, MN, 55440-1022, US

(21) Appl. No.: 11/670,039

(22) Filed: Feb. 1, 2007

(51) Int. Cl. G06Q 40/00

(52) U.S. Cl. 705/36 R

(57) ABSTRACT

A body of information elements is maintained including facts, assumptions, and relationships, at least one element being generated from the others using the relationships and representative of an estimate of a value of, or a market size of a product or service associated with, an asset. The relationships each define how a resulting fact or assumption can be generated from at least one source fact or assumption. The way in which the at least one source fact or assumption can be generated from another source fact or assumption is defined in each of multiple instances by one of the relationships. The body of information is exposed through a publicly accessible communication medium on a non-discriminatory basis. On the communication medium, users are enabled to engage in moderated collective discussion concerning the information elements. Users are enabled to participate financially in contracts having values that are tied to the estimated value of the asset.

### TECHNICAL FIELD

This description relates to estimating values of assets.

### BACKGROUND

Valuing tangible and intangible assets consumes large amounts of human resources, and the valuation estimates that result are relied on for a broad range of economic and other decisions and activities. The assets being valued include, among other things, individual items (and groups of items) of tangible personal and real property, entire enterprises such as corporations, governmental bodies, institutions, financial instruments such as stocks and bonds in public and private companies, and intangible assets such as intellectual property and good will. Much of the description here is cast in terms of several specific types of financial instruments, such as stocks, bonds, currencies, commodities, and financial derivatives, like options and futures contract written on stocks, bonds, currencies and commodities. Yet, the concepts put forward here apply broadly to assets of all kinds and to approaches to valuing them.

Some approaches to valuation of an asset are directed to determining what may be called the present intrinsic value of the asset. One classic definition of present intrinsic value is the sum of present values of all future cash flows that are expected (discounted based on some definable risk) to flow from the asset. Such a present intrinsic value represents the price at which a potential owner of the asset would be indifferent between owning the asset or owning a stream of cash flows that have the same risk as the expected cash flows of the asset. As a corollary, when the price of such an asset is below the intrinsic value, potential owners are expected to prefer buying the asset at that price, thus increasing its demand and in turn the price, and to continue to do so until the present price is equal to the present intrinsic value. Conversely, when the present price exceeds the present intrinsic value, owners of the asset will prefer to sell the asset and to continue to do so until the present price (we sometimes refer to the present price as simply the price) drops to the present intrinsic value (we sometimes refer to the present intrinsic value as simply the intrinsic value).

The intrinsic value of an asset and the factors that influence it are important to a wide range of people (including families, and groups of them) and enterprises (we use the term enterprises broadly to include corporations, governments, institutions, and any other kind of legal entity). We sometimes use the term interested parties or parties in the broadest sense to include any people or enterprises that have an interest in the value of assets.

Interested parties can include parties who have time, money, or other assets to invest (we sometimes call them simply investors) and other people who are not investors but are interested in the values of assets for other reasons.

Investors must make decisions about investments of their assets, even if the decisions are to do nothing (for example, by stashing cash) and allow the assets to garner no yield. More typically, though, the goal of interested parties is to maximize value from their assets.

As part of reaching this goal, virtually all interested parties care about the intrinsic value of an asset and the factors on which it depends. As investors develop an estimate of the intrinsic value of an asset, they tend to buy the asset when its price is at or below the estimated intrinsic value, and sell the asset at or above its estimated intrinsic value. Investors may believe that the market traded price of an asset will move towards the intrinsic value. Individuals may commonly expect the market price of an asset at a point of time in future, to be equal to the estimated intrinsic value of the asset at that future time.

Interested parties may also include people who are not themselves direct investors. For example, present and potential managers of a company, its consultants, bankers, and lawyers all strive to understand the intrinsic value of the enterprise and the factors that affect the intrinsic value, for a wide variety of purposes. Among other things, understanding the value and the factors helps them to identify and focus their efforts on actions that can sustain or increase the value (we sometimes refer to intrinsic value simply as value), with the expectation of receiving a part of value because of their involvement.

Interested parties may also include present and potential employees of enterprises, who may want to spend their time and effort in companies and markets offering good opportunities for them to sustain and increase value and capture a portion of it for themselves. An employee of a company that has a shrinking value, or of a department of a company that does little to add value to the enterprise, can hardly expect to thrive personally.

Entrepreneurs are interested parties who use their understanding of intrinsic values of assets within a market, and the drivers of value, to make decisions on where and how to spend their time and effort, planning actions that will enhance the value, allowing them to capture a part of it.

Estimates of values of assets are available from a wide variety of sources in various contexts, including newspapers, magazines, analysts' reports, and other conventional publications, and web sites and proprietary on-line information terminals. Some sources provide detailed expert analysis of an asset's value. Others aggregate information from other sources at a single portal.

Generally, an analyst's report on the stock of a company, for example, is a static publication that an investor may read to gain some understanding of the analyst's reasoning. Other investors may simply refer to the analyst's conclusion about how much a stock is worth without reviewing the basis of his opinion. Some of the raw data that the analyst used in forming his opinion may be repeated in the report, but the report generally does not provide access to raw data and models used by the analyst in its creation. Publications that aggregate information from other sources may provide access back to those sources, but generally do not perform analysis of their own, other than the initial selection of what information to collect and distribute.

Financial analysts use a variety of models and other qualitative and quantitative approaches together with facts and assumptions to research, estimate, and report values of assets.

Values of certain financial instruments depend on the value of an underlying asset or the occurrence of an event. Examples of such contracts or rights are options, futures, and event contracts. In an American option, for example, an investor purchases a right but not an obligation, to buy (a call option) or sell (a put option) a specific asset at a specified price at some time on or prior to a future date. A futures contract is an agreement to buy or sell a fixed quantity of a specified commodity, currency, or security for delivery at a fixed date in the future at a fixed price. An event contract pays (or does not pay) based on the occurrence or non-occurrence of some future event. It may be binary, for example, paying based on whether or not a company's revenue growth beats inflation, or it may be variable, for example, paying based on the amount by which the company's revenue growth beat inflation.

In the field of asset valuation, some sources charge directly for the information they make available. In some cases (for example, financial websites that aggregate information from other sources), advertising revenue allows a source to provide the information free. Parties that provide users a platform to trade stocks, bonds, and contracts can generate revenue by charging a commission on a per trade basis or on the volume of the transaction.

Independent research and Wall Street firms like Lehman Brothers and Goldman Sachs have analysts who estimate values of assets, for example, the stock of a company. They communicate their estimates and analysis in periodic write-ups shared through electronic files, for example, PDF files, or on paper. They also create additional material to share, for example, spreadsheets. The shared spreadsheets include some of the assumptions, facts, and calculations used in the computation of the value of the asset or other results. The spreadsheets and write-ups can be distributed internally to relevant people at the research firm for comment and use and in some cases for duplication and alteration by others to serve their own purposes. The spreadsheets and write-ups can also be provided to people outside of the firm (e.g., their customers) for the same reasons. Any distribution outside of the firm is, at the first level, controlled by the firm for its own purposes. For that reason, a spreadsheet or write-up that is distributed outside of the firm typically includes only a subset of information useful in understanding the derivation of the value estimate, and other results.

The distribution serves to stimulate inquiries from possible customers. Customers external to the firm may rely on their own ability to synthesize information from various sources to derive insights that are unique and that may allow them to monetize on their unique views. The people to whom the spreadsheet is distributed (either internally or externally) can engage in discussion (commonly with the people within the research firm who are responsible for generating such estimates, the creators) by email, or over the phone, about the models, and those discussions may lead to changes in the model being made by the creator.

Anyone with an account at the research firm (and that could be anyone in the public) may have access to some of these shared models and write-ups on the firm's website.

Discussion websites on topics that relate to values of assets such as stock allow any person who has access to the internet to log on and review comments of others and offer comments himself. These sites thus enable a community of the public to democratically discuss issues around the values of assets. In some cases, the sites are moderated by a central authority. In addition, aggregator websites may have expert opinions on products, markets, companies or stocks. These opinions are a general discussion of some of the issues of interest, or common appeal and are typically directional, qualitative indicators or views.

### SUMMARY

In general, in an aspect, a body of information elements is maintained including facts, assumptions, and relationships, at least one of the information elements being a resulting element that is (a) generated from the other facts and assumptions using the relationships, and (b) representative of an estimate of a value of, or a market size of a product or service associated with, an asset. The relationships that belong to the body of information each define how a resulting fact or assumption that belongs to the body of information can be generated from at least one source fact or assumption that belongs to the body of information. The way in which a source fact or assumption can be generated from another source fact or assumption is defined in each of multiple instances by one of the relationships that belong to the body of information. The body of information is exposed through a publicly accessible communication medium on a non-discriminatory basis.

In general, in an aspect, a body of information elements is maintained including facts, assumptions, and relationships. At least one of the information elements is a resulting element that is (a) generated from the other facts and assumptions using the relationships, and (b) representative of an estimate of a value of, or a market size of a product or service associated with, an asset. The relationships that belong to the body of information each define how a resulting fact or assumption that belongs to the body of information can be generated from at least one source fact or assumption that belongs to the body of information. The way in which the source fact or assumption can be generated from another source fact or assumption is defined in each of multiple instances by another one of the relationships that belongs to the body of information. On a medium in which the body of information is exposed to users, users are enabled to engage in collective discussion concerning the information elements.

In general, in an aspect, a body of information elements is maintained including facts, assumptions, and relationships, at least one of the information elements being (a) generated from the other facts and assumptions using the relationships, and (b) representative of an estimate of a value of, or a market size of a product or service associated with, an asset. The relationships that belong to the moderated body of information each define how a resulting fact or assumption that belongs to the body of information can be generated from at least one source fact or assumption that belongs to the body of information. The way in which the source fact or assumption can be generated from another source fact or assumption is defined in each of multiple instances by another one of the relationships that belongs to the body of information. On a medium in which the body of information is exposed to users, a moderator is enabled to participate in collective discussion by users concerning the information elements.

In general, in an aspect, a body of information elements is maintained including facts, assumptions, and relationships, at least one of the information elements being (a) generated from the other facts and assumptions using the relationships, and (b) representative of an estimate of a value of, or a market size of a product or service associated with, an asset. The relationships that belong to the body of information each define how a resulting fact or assumption that belongs to the body of information can be generated from at least one source fact or assumption that belongs to the body of information. The way in which the source fact or assumption can be generated from another source fact or assumption is defined in each of multiple instances by another one of the relationships that belongs to the body of information. Through a medium in which the body of information is exposed to users, users are enabled to participate financially in contracts having values that are tied to the estimated value of the asset.

Implementations may include one or more of the following features. The users are enabled to participate in the contracts on the medium. The users are enabled to enter bids for the contracts on the medium. The body of information is exposed through a publicly accessible communication medium on a non-discriminatory basis. On the medium, users are enabled to engage in collective discussion concerning the information elements. On the medium, a moderator is enabled to participate in collective discussion by users concerning the information elements. On the medium, a moderator is enabled to participate in collective discussion by users concerning the information elements. On the medium, users are enabled to engage in collective discussion concerning the information elements. Other facts, assumptions, or relationships are maintained that are not part of the body of information, the resulting element not being generated from the other facts, assumptions, or relationships. The contracts include financial derivatives defined on events associated with an asset.

A controlled version of the body of information elements is maintained that is not modifiable by users except as allowed by a controlling authority. A user is enabled to modify a copy of at least a portion of the body of information elements. The user is enabled to save the modified copy and share the saved copy with other users on the same medium in which the body of information is exposed.

The medium comprises an online interactive communication medium. The medium comprises a browser.

Maintaining the body of information includes at least one of storing, updating, and retrieving at least a portion of the body of information on a server that is available to users through a publicly accessible communication network. The body of information includes resulting elements representative of estimated values of, or a market size of a product or service associated with, more than one asset.

An initial body of information is generated by experts. The experts comprise financial experts and experts in design or development of information on the communication medium working collaboratively. An electronic data interface enables interactions of the financial experts with the experts in design or development of information. At least some of the facts and assumptions are received electronically from external sources. At least some of the facts and assumptions are received electronically from experts. At least one of the experts is located in a country in which expert costs are lower (e.g., India). The body of information is updated by the experts over time. The body of information is updated based on new facts and assumptions relevant to the resulting element. The body of information is altered to improve the ability of users to study, discuss, and use the body of information. The altering is done continuously as information becomes available. The altering is done automatically in real time using electronic feeds. The altered body of information includes archived information about the body of information prior to alteration. The financial experts control the substance and structure of the updated body of information and the experts in the design or development of information maintain and update the implementation of the substance and structure. The experts derive assumptions from discussions with other experts and company managers.

At least one of the relationships comprises a mathematical operator or mathematical relationship. Each of the relationships comprises a mathematical operator or mathematical relationship. At least one of the relationships comprises a calculation in which a level of one of the facts or assumptions is used to derive a level of another of the facts or assumptions. Each of the relationships comprises a calculation in which a level of one of the facts or assumptions is used to derive a level of another of the facts or assumptions. The levels of facts and assumptions are numerical. At least some of the relationships comprise a calculation in which the sensitivity of one of the facts or assumptions is determined with respect to another of the facts or assumptions. At least some of the relationships comprise an opinion of a user about one of the facts or assumptions.

One of the facts or assumptions comprises an opinion on another one of the facts or assumptions. At least one of the assumptions comprises at least one of the following with respect to a company in a future time period: revenue expected to be generated in aggregate or from a product, service, or an offering associated with stock of the company; cash flow; earnings per share; or net income. The resulting element comprises a possible range for the value of the asset, or the market size of a product or service associated with an asset. The resulting element comprises a possible range for expected values or expected market prices of the asset, or the market size of a product or service associated with an asset, at a future time.

An investment vehicle associated with the asset may be made available for trading by one or more of the users, the body of information comprising an estimated value of the investment vehicle. The asset comprises common stock of a publicly traded company. The investment vehicle comprises a contract between a buyer and a seller based on the value of the investment vehicle. The investment vehicle comprises a financial derivative defined on events associated with an asset. The asset comprises a security. The asset comprises stock of a company. The asset comprises stock of a public company. The asset comprises stock of a company that intends to raise new capital, and the body of information enables users to study an estimated value of the stock to be issued to raise the capital. Users are enabled to apply for ownership of at least a part of the capital by entering bids for the stock to be issued to raise the capital. The new capital is to be raised in an Initial Public Offering (IPO). Users are enabled to enter bids for the asset.

Exposing the body of information includes providing an interactive navigational environment to enable the user to explore the facts, assumptions, and relationships. Exposing the body of information includes displaying portions of the body of information to a user. Exposing the body of information includes displaying a portion of less than all of the body of information and displaying a navigational element that can be invoked to have another portion of the body of information displayed. The navigational element comprises a link representing at least one of the relationships. More than one navigational element can be invoked with respect to a given one of the portions of the body of information.

The exposing includes enabling users to engage in discussions about at least some of the elements. The discussions include proposed alterations to at least one of the facts or assumptions or relationships. Specific users are barred, based on their conduct, from engaging in the discussions. The discussions are accessible to other users. At least some of the discussions are incorporated as part of the body of information. The body of information is updated based on the discussions. The discussions are arranged based on an estimated skill of users with respect to the discussions. The exposing includes posting questions on topics of interest to users and enabling users to post opinions or answers in response. The user responses are analyzed to derive useful information and the generated information is incorporated into the body of information elements. The exposing includes enabling users to understand sensitivities of facts and assumptions to changes in other facts and assumptions. The exposing includes enabling users to understand sensitivities of the estimated value of the asset to facts and assumptions. The exposing comprises making the body of information available to the users electronically by an electronic feed to a website host. The exposing comprises displaying. The exposing comprises enabling a user to navigate through the relationships, facts and assumptions. The exposing comprises displaying portions of the body of information and providing navigational features to enable a user to study the multiple instances of relationships, the resulting facts and assumptions, the source facts and assumptions used to generate them using the relationships, and the other relationships used to generate the source facts and assumptions.

The exposing comprises enabling users to study the facts, assumptions, and relationships, by displaying portions of the body of information, each of the portions including at least one of the resulting facts or assumptions and a navigational element that is associated with one of the relationships and, when invoked, causes display of another of the portions that includes a fact or assumption that is a source fact or assumption with respect to the resulting fact or assumption and the relationship associated with the navigational element. In each of multiple instances, the one other portion includes (a) the source fact or assumption which is also a resulting fact or assumption and (b) an interactive navigational element that is associated with another one of the relationships and, when invoked, causes display of a third portion that includes a fact or assumption that is a source fact or assumption with respect to the resulting fact or assumption of the one other portion, and the relationship associated with the navigational element. The exposing includes exposing essentially all of the elements of the body of information that a user would need to know in order to understand how the resulting element is generated. The exposing includes exposing all of the elements of the body of information without withholding any.

Among the advantages of the concepts described here are one or more of the following. The particular interests, knowledge, and skills of individuals that may relate to at least some aspect of an asset can be used effectively to enable (and encourage) the user to participate in evaluating, discussing, and learning about assets, their values, and factors that drive their values. A person can buy and sell interests in contracts that are tied to estimates of values of assets, key parameters that influence values of assets, and parts of assets and in that way to profit from his personal interests, knowledge, and skills. How a single asset may be divided into parts that people may invest in is discussed in detail below. Hosts of online services can profit from providing an interactive forum and offerings of contracts available to individuals. A medium can be provided for advertisers to place effective advertising associated with assets and their values. The paradigm under which people view valuations of assets may develop a focus based on concepts such as technology, or market, or geography, or politics, or events that influence values of assets, instead of on assets themselves in their entirety. The information can be made transparent down to the lowest level for anyone to use, contribute to, and view.

These and other aspects and features and combinations of them may be expressed as methods, apparatus, systems, program products, means or steps for performing functions, and in other ways.

Other advantages and features will become apparent from the following description and from the claims.

### DESCRIPTION

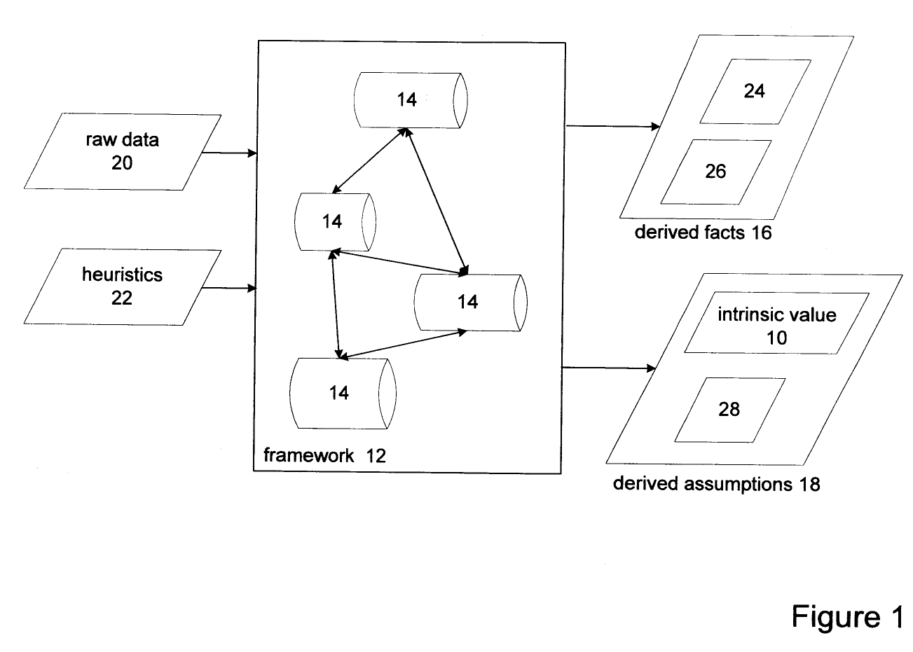

FIGS. 1, 2A, 2C, 6, 7, and 33 show block diagrams of asset valuation systems.

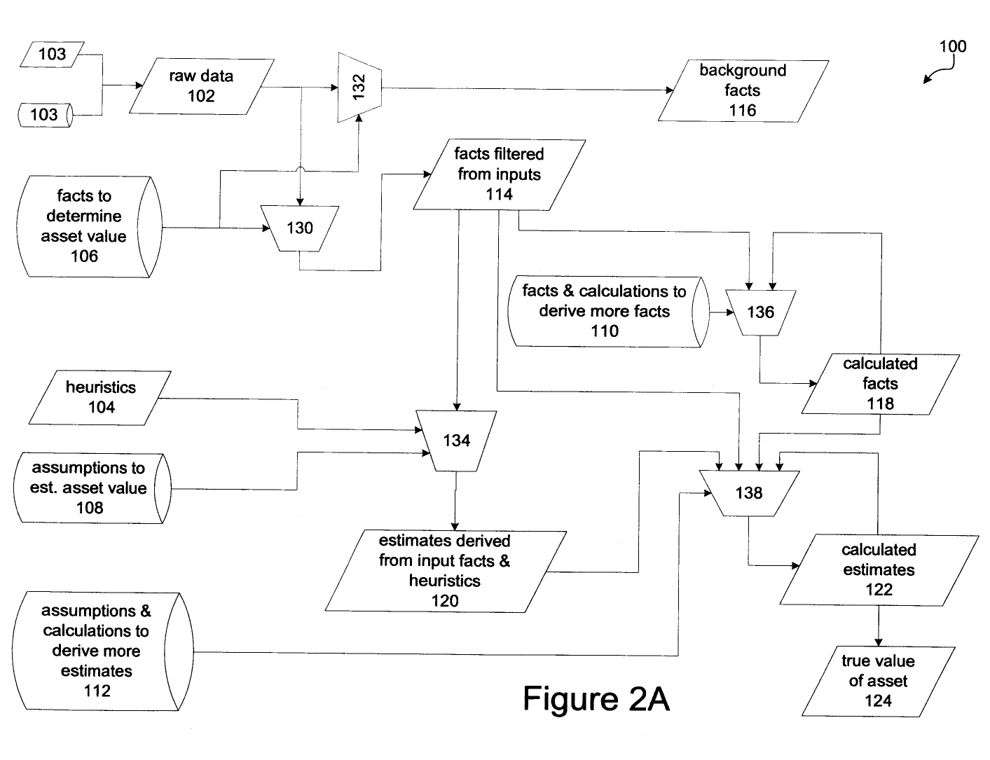

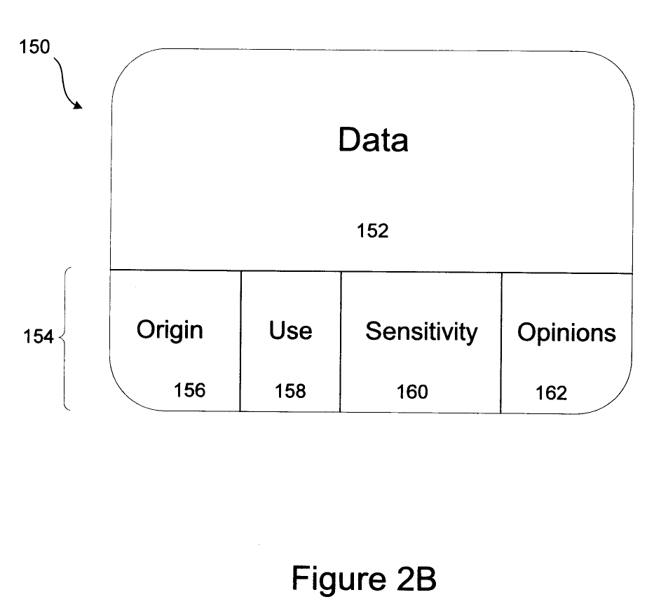

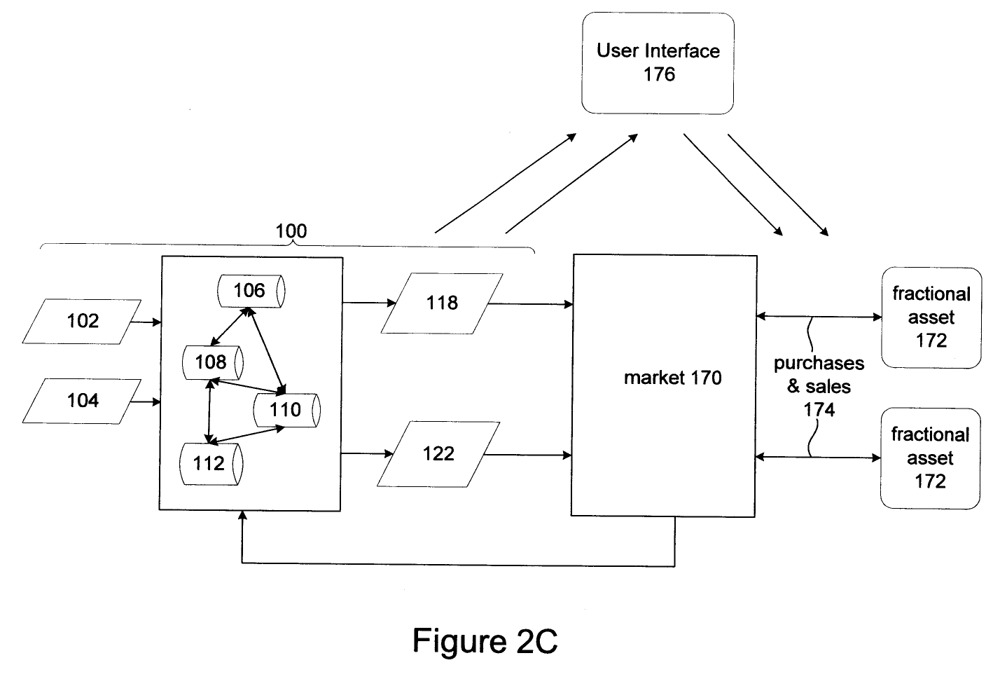

FIG. 2B shows a block diagram of a data structure in an asset valuation system.

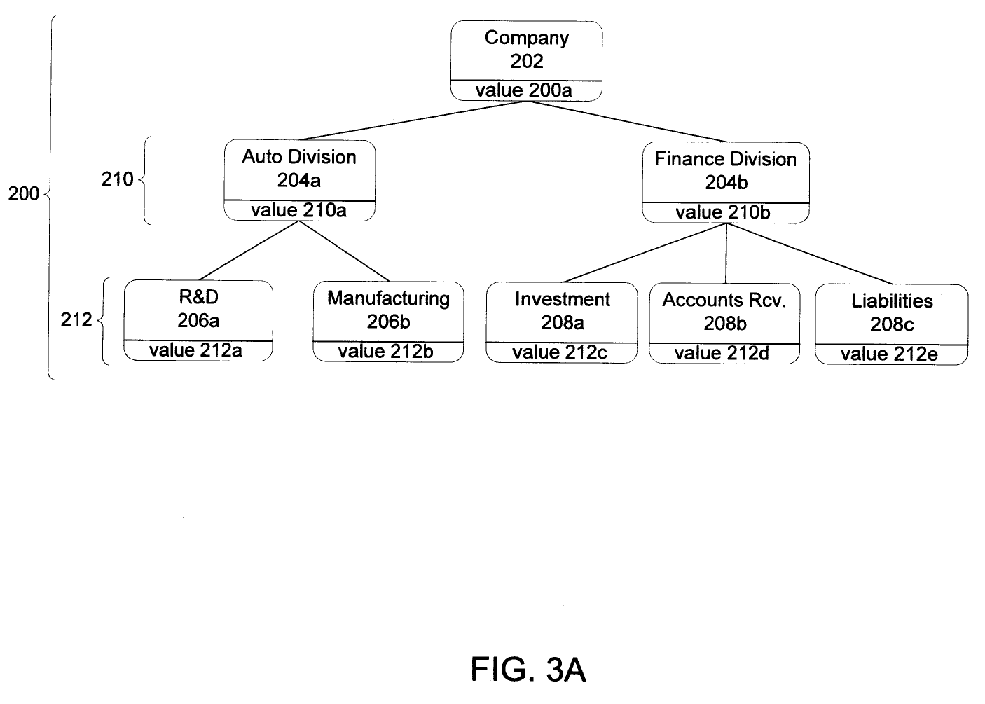

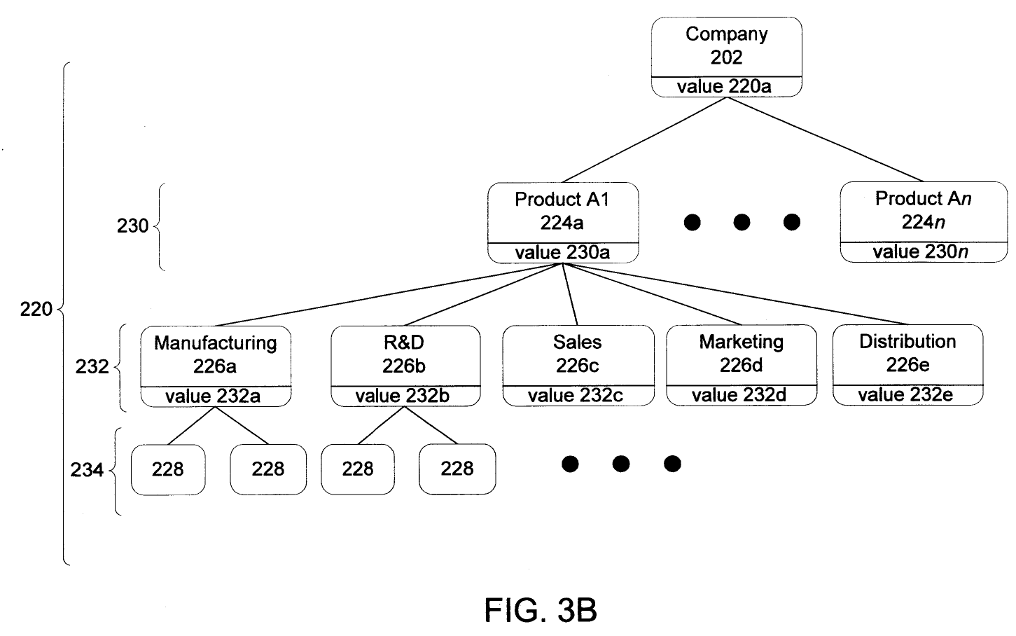

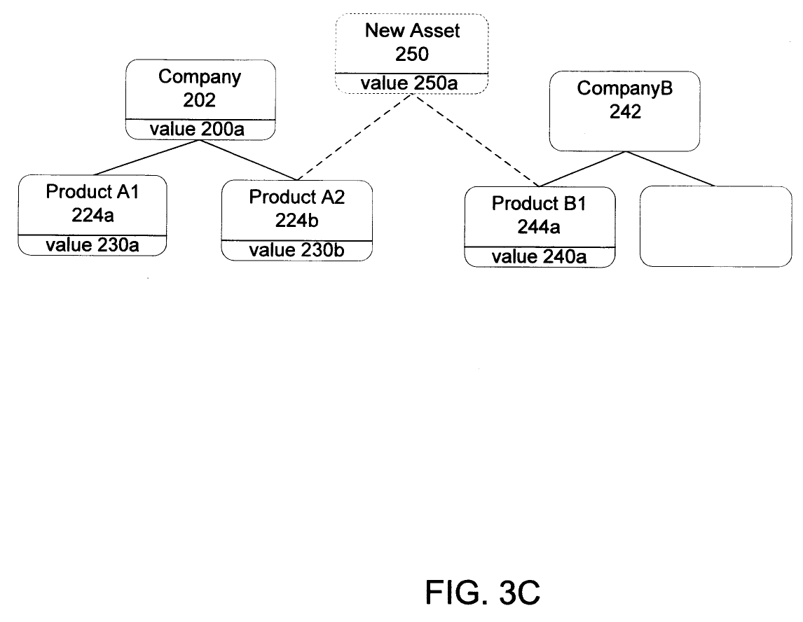

FIGS. 3A-3C show hierarchies of data.

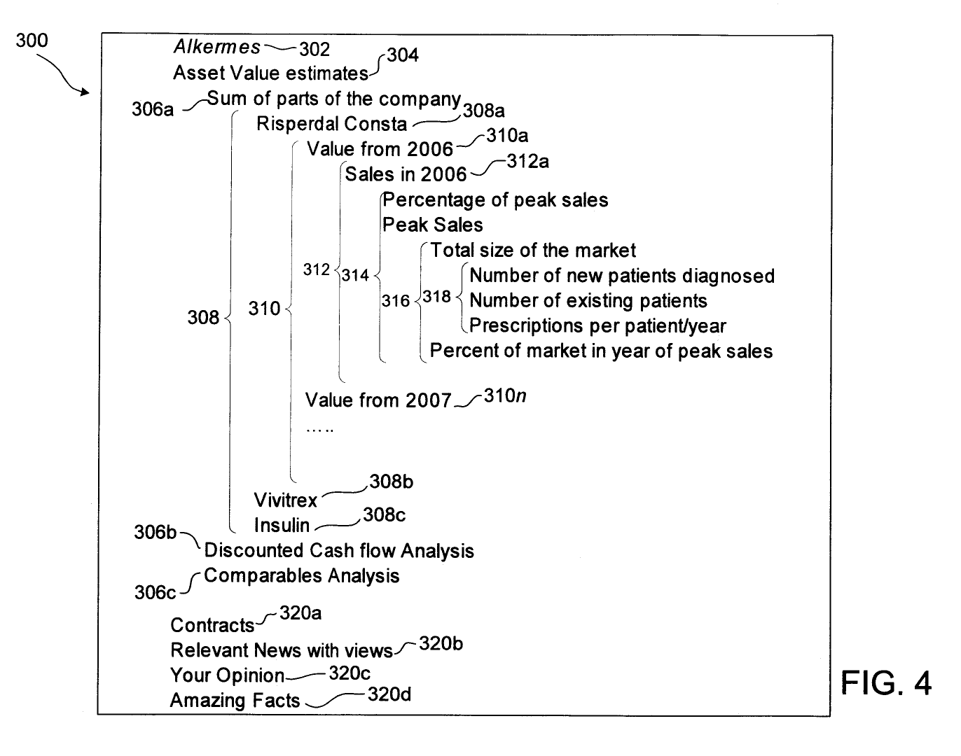

FIGS. 4, 5, and 8-32 show user interface screens.

### OVERVIEW

As shown in FIG. 1, a present intrinsic (sometimes called true) value of an asset 10 can be determined using a framework 12 that is a set of rules 14 (for example, a model or other analytical or computational approach) that identifies facts 16 and assumptions 18 that are to be derived (the estimated value of the asset 10 is one of the assumptions to be derived) and how they are to be derived from underlying raw inputs 20 and heuristics 22. We sometimes refer to rules as relationships. The outputs of the framework are derived facts 16 and assumptions 18, which may include supporting facts 24, calculated facts 26, and estimates (calculated assumptions) 28.

The raw inputs and heuristics are themselves facts and assumptions. The term heuristic includes any kind of expert opinion or commonly accepted assumption. Together the rules or relationships and the raw and derived facts and assumptions make up a body of information and are sometimes called elements of the body of information.

The term fact includes any piece of information describing a past or present circumstance, for example, the price per kg of Ti yesterday or the current membership of the board of directors of a company. A fact may be derived from another fact using a defined relationship, e.g., fact2=f(fact1).

The term assumption includes a piece of information that is not presently objectively verifiable, for example, tomorrow's price of Ti, or that a product will be released on time. An assumption may be derived from facts and other assumptions using a defined relationship or chain of relationships, e.g., assumption41=f(fact1), assumption42=f(fact1,assumption41), assumption42=f(assumption41). For example, the statement that ABC stock will be worth $10 on December 1, based on its current price of $5 and the expectation that the new product will launch by November 23, is an assumption derived from a fact and another assumption. This derivation may be a heuristic (an expert thinks new products double stock prices) or a functional calculation (the expected additional cash flows from the new product when discounted to December 1 amount to a $5/share value.) As mentioned earlier, the present intrinsic value of an asset is an assumption and is sometimes called a resulting element of a body of information.

Estimating the intrinsic value of an asset (which we sometimes call a resulting element of a body of information) requires collecting information from many sources. In addition, the estimation commonly requires exercise of judgment on the information to be used, the facts and assumptions needed, and calculations employed. Calculations are then performed on the facts and assumptions, and on results of these calculations, to ultimately arrive at an estimate of intrinsic value.

Due to the judgment involved, estimates derived by different interested parties are commonly different for a given asset. Moreover, since calculation of intrinsic value commonly involves predictions into the future, the intrinsic value cannot be known for certain. As a result, in order to make decisions on the allocation of their time and assets, it is useful for interested parties to develop an understanding of the estimate of the intrinsic value and of the factors that it depends on. Involvement of significant judgment in estimations of expected cash flows from an asset, and in estimating risk of individual cash flows, makes it non-trivial to estimate asset value. Individuals may commonly be interested in an estimated range for the intrinsic value of assets, to better reflect the uncertainty involved and judgment employed in the estimations. The system described here may provide an estimated range of intrinsic value of assets. In addition, individuals are often interested in the expected market price at a future time period, for example, over a 6 month, 1 year, or 5 year timeframe. Commonly, individuals may expect the market price at a future time to be equal to the estimate of intrinsic value at that future time. The system described here may provide estimates of the expected market price or value of an asset, at a future time point, for different assets.

Additionally, individuals commonly are interested in a company due to certain products, markets, or events they are familiar with or have read about. Estimates of the size of the overall market for the markets within which the product or service may exist are of significant interest to users. Such estimates provide an indication of the size or the value of the product or service of interest and help individuals understand the value of the company in context of the product or service. The system described here can provide such estimates.

Price movements in the financial markets may also occur due to imbalances between demand and supply for the asset. These imbalances are commonly transient, however, they could be more frequent for some assets than others. Due to such imbalances, the expectation of future prices may differ from the expectation of the intrinsic value of an asset. In addition to supply and demand imbalances, there may be other forces that affect the value of an asset. The system described here may also incorporate these supply and demand imbalances and other forces in models or frameworks in deriving the estimate of the expected price of the asset at a future time.

Interested parties who care about the intrinsic value of an asset and the factors that depend on it may develop their own estimates or use estimates provided by others. Because of the work involved in searching, collecting information, performing calculations, and making judgments about information and calculations to use, this is time consuming and requires skill. Estimates provided by others are most useful to interested parties if they can understand the estimates and the factors that they depend upon, which helps them to develop confidence in the estimates.

When estimates of intrinsic value are provided to interested parties, they are made more useful if they are disclosed in a transparent way, that is, by exposing to the recipient without reservation all of the facts, assumptions, heuristics, and other bases for the estimates and the details of the framework that was used to derive the value from the base information. For example, it is helpful to enable the interested parties to have the option to see each of the calculations performed, the explanation for each calculation, the information used in each calculation, the origin of such information, and the judgments made in selecting the information and the calculations used. For example, if an asset is stock in a company that intends to raise capital, possibly in an initial public offering (IPO), the interested parties may want to study an estimated value of the stock to be issued in the IPO. Being able to provide a variety of such options, without cluttering the content, can be used to cater to a large audience.

By enabling easy access to such transparent information, and organizing the information in hierarchical layers, interested parties can quickly form and refine views, compare their opinions with those presented, and develop confidence in the developed estimate, without being overwhelmed by the comprehensiveness or complexity of the presented information. Users across organizations, and even strangers may be able to collectively discuss the presented content on the medium itself. While viewing the content, users may also be offered the opportunity to invest in the assets they are examining, for example, by directly purchasing traded assets or entering bids, as appropriate.

There is value in not discriminating between users in deciding whether to allow them access to information, and how much information to allow access to different individuals or groups, based on difference in expected financial benefits from them.

Such content may be presented along with user surveys, or even stand-alone questions on products, markets, and events, allowing users to participate in them. Questions may be integrated within the content at relevant points to help users better engage with the related content by asking them questions relevant to the content they may be interested in. Information collected and analyzed from the surveys and questions may be used to update the model.

A wide variety of techniques can be used to enable an interested party (we sometimes will refer to interested parties simply as users) to navigate quickly and easily within a hierarchically organized body of valuation information (we sometimes use the term content to refer to the information). For example, web browsing links can be provided within the content. Numbered options may be integrated at different places within the content without cluttering the visibility and readability of the main content or the flow of the content for estimating intrinsic value.

Users may also be provided with options to see explicitly the effect of a change in any information displayed, calculations used, or judgments employed, on the intrinsic value estimate and other derived or calculated information. In addition users may be provided options to alter the information and calculations used, and insert their own judgments about information and calculations used at selected places in the framework, as well as save the changes introduced for later access or sharing with other users. This will allow the users to leverage the existing content while developing their own estimate for intrinsic value. Users may also be provided options to share their opinions or pose questions on specific information, calculations, and judgments used. The in-house analyst can answer questions and participate in and steer discussions originating from such exchanges of opinions in the right direction.

By developing transparent intrinsic value estimates for a wide variety of assets, and an easily navigated medium in which users can contribute to, review, analyze, understand, and modify the content (facts and assumptions, for example) and frameworks (relationships and chains of relationships, for example) underlying the estimates, the system described here will enable the development of a broadly accepted, widely used value-centric view of the world. By value-centric view of the world, we mean, for example, a broad understanding of what value is and how it is explained at any level of the hierarchy, rather than simply at the top level of an asset or enterprise. The system described here is a powerful tool (one that matches more closely the real world) for understanding and investing in the results of human activity.

A value-centric view of the world provides a value-based lens into various different disciplines ranging from science, technology, markets, consumer behavior, and human psychology. It considers value creation as the central goal of human endeavor, and attempts to understand value and the factors that drive value by primarily asking and answering the questions: what are the assets whose value a discipline or concept impacts or is expected to impact, how, and by how much. It analyzes the parameters, facts, and assumptions within a discipline that affect values of different assets and tries to quantify them. Such a view of the world allows individuals to explicitly see, assess, question, and compare various disparate disciplines of human activity with respect to their estimated worth and their influence on values of different assets of interest.

This is achieved through a network of structured information, where information at any level may be accessed to understand its usefulness in estimating values of different assets. In this way information from different disciplines may be brought together while laying out clearly what is useful, in which contexts, and how, and separating out other or similar information that may be less useful. Other categories of information may include gossip or other information of questionable quality. By selecting information that is expected to be most useful and then structuring and placing it in context of the ‘so what,’ the system described here addresses the information overload problem.

Users are able to see from the lens of a certain technology, or any other area, directly into the assets that it impacts, how, and by how much. For example, when someone searches for stents, he sees as results the top companies that make stent products, the present market price of these companies, and estimates of their value. In addition, users can see the specific products that use stents and estimates of relative market share (a metric that can be more easily measured and tracked and is an indicator of relative value) of these products, and the reasons for the difference. Further, for a specific type of stent technology, the user will see the products that use that technology and the aggregate of the estimated market share of the products.

Owing to the inherent nature of uncertainty, estimates of value or price commonly turn out to be different from the realized price. Due to this, in sharing views on asset value or price, it can be most useful to explicitly lay out, without cluttering, the complete set of relevant facts, assumptions, and relationships used in estimating asset value or price. The system can be built to provide users options to navigate through different portions of the content based on their present knowledge level, curiosity, interests, and skill, to easily understand the content and leverage to their best advantage and without being overwhelmed. Further, users can be allowed to collectively discuss the content at specific granular levels of facts, assumptions, and relationships within products, markets, and events they understand and are close to. Stand-alone questions or surveys can also be placed within the context of relevant content at different points within the content. Such questions can be centered around different products, markets, or events with which individuals are familiar and to which they are close in order to further engage the users, help better understand the content itself, and allow the users to share their views. An in-house analyst (who can serve, for example as a moderator of the body of information) can refine the content based on the on-going discussion and responses to the questions, making it more attractive for additional users. Over time, because of the openness and structure of such a system, allowing complete participation from all users to their desired level, such a platform can grow into a gold standard for sharing views on asset value.

Such a transparent, value-centric, view of the world may change the way interested parties make decisions about their time and asset allocation. Interested parties with an understanding of value, and its drivers, will be better equipped to create and appropriate value. An understanding of markets and drivers of value may also enhance entrepreneurship and create additional opportunities for value creation in the economy. Over time it will change the way interested parties participate in capital and labor markets, and how corporations raise capital and share information with the public.

As shown in an idealized form in FIG. 3A, described in greater detail below, an asset 202 can be viewed as comprising an aggregation 200 of components 204, 206, 208 at multiple hierarchical levels 210, 212. Each component may have a value 21 On, 212n that contributes to an aggregated value of a component at higher levels of the hierarchy (i.e., in FIG. 3A, value 210a=value 212a+value 212b). These values may be actual or intrinsic financial values, or they may be abstract parameters, for example, the probability of a favorable decision on a lawsuit. As one example, the value (200a) of a share of stock of General Motors (company 202) could be viewed as an aggregation of the values of the automotive divisions (204a), and the non-automotive divisions (204b), and the value (210a) of an automotive division could be viewed as an aggregation of the values (212a, b) of the specific operations (206a, b) of that division, while the value (210b) of a non-automotive division could depend on the value (212c) of an investment (208), for example, in automobile financing. Some frameworks may use models other than hierarchies, depending on the interrelationships between components in the type of asset being valued.

Transparently exposing to users all of the content and framework details associated with the components of an asset, enhances the users' ability to understand value and factors that influence value at all levels of the hierarchy. Among other things, it is possible to define investment vehicles whose values depend explicitly and primarily on specific key parameters that affect the value of an asset. Thus, a user who has deep knowledge about the market for Corvettes may be able to invest in a contract whose payoffs are explicitly and primarily linked to the value of the Corvette model within the Chevrolet automotive division of General Motors. Further, contracts may be defined with payoffs explicitly linked to other key parameters that influence the value of the Corvette model or that are believed to be predictors of the value of the Corvette model, for example, the number of units of the car expected to be sold within the next year. The value of such an investment vehicle is affected by factors that the user understands, and is interested in. By transparently providing all the underlying information associated with that component the user can invest or make other decisions about the value more confidently because he can evaluate the value using his own expertise.

FIG. 2A shows an overall view of an asset value estimation system 100. This system implements a more-complicated version of the framework in FIG. 1, with, among other things, multiple feedback loops, outputs re-used as inputs, and multiple paths from the inputs to the outputs. One input to the system is raw data 102, which may include news and information releases, such as company press releases and regulatory filings, commonly known information in different fields of science, technology, markets, finance, consumer behavior and others which are expected to be meaningful for the value of assets. The raw data may also include information from surveys, expert opinions or comments from discussions conducted in-house or externally, privately or publicly. The raw data can be drawn from electronic feeds, printed materials, and a wide variety of other sources 103.

Another input may be heuristics 104. These are rules derived from the experience of analysts or external experts, or are commonly understood assumptions relevant to the estimate of value of an asset. For example, a heuristic could be that if the economy grows more than 4 percent in a year, automobile prices rise the next year. This may be based on the fact that in the past, automobile prices have always risen in the year after a year in which the economy grew more than 4 percent. Heuristics are commonly based on relevant facts and are best understood when placed in the context of such facts. The platform can include heuristics in context with the facts relevant to the heuristic to allow individuals to better understand the content and its context.

Other inputs 106, 108, 110, and 112 are used by the system 100 and collectively characterize a given framework. An identification 106 of facts from the raw data 102 controls, through a filter 130, which facts 114 can be used in subsequent calculations to determine asset value. Identification of assumptions 108 is used in combination with the identified facts 114, in a computation 134 to generate estimates 120 directly from the heuristics 104. These are referred to as direct estimates. Some of the raw data 102 may also be identified by the inputs 106 as background information 116 (filter 132), such as an explanation of different scientific or financial terms or models underlying the framework. One framework input is an identification 110 of facts and calculations that can be used to calculate (136) additional facts 118 from the filtered facts 114 and other calculated facts 118. In some examples, the derivation of some outputs does not use all the inputs enumerated, for example, some additional facts 118 may not use other additional facts 118 in their calculation. Another framework input is an identification 112 of assumptions and calculations that can be used to calculate (138) additional estimates 122 from the input facts 114, the direct estimates 120, the calculated facts 118, and previous calculated estimates 122. One of the calculated estimates 122 is a resulting element that is the estimate of intrinsic value 124 of the asset. The framework inputs, outputs, and calculations may be referred to generically as parts or elements of the framework. Thus the framework, in some examples, can be viewed as a body of information elements (facts, assumptions, and relationships).

The framework inputs 106, 108, 110, and 112 include not only the identification of the facts, assumptions, and calculations (e.g., relationships) useful to generate outputs from the inputs, but also information on the specific relationships between the different inputs and the outputs. The information about these relationships is useful in understanding how an output fact or assumption is generated from the different input facts and assumptions.

For example, inputs 106 include information on different relationships between the raw data 102 and facts 114 that are useful in understanding how the different facts 114 are generated. Inputs 106 also include information on different relationships between the raw data 102 and background information 116 that are useful in understanding how the different background information element 116 are generated. Inputs 108 include information on different relationships between the facts 114, heuristics 104 and the direct estimates 120, that are useful in understanding how the different direct estimates 120 are generated. Inputs 110 include information on different relationships between the facts 114, other calculated facts 118 and the calculated facts 118, that are useful in understanding how the different calculated facts 118 are generated. Inputs 112 include information on different relationships between the facts 114, calculated facts 118, direct estimates 120, other calculated estimates 122 and the calculated estimates 122 that are useful in understanding how the different calculated estimates 122 are generated. Expressing (e.g., explicitly laying out, displaying, and permitting navigation with respect to) these input and output facts and assumptions, including the relationships, allows users an option to completely understand how the asset value estimate or other resulting element has been derived. Such information on different relationships may itself consist of facts and assumptions that are logical or mathematical, or may describe other commonly known relationships. This information may include mathematical or logical operators or other symbols that represent the relationship between the different elements.

Within the system 100, facts and assumptions used to generate other facts and assumptions may be referred to as source facts and assumptions, while the facts and assumptions generated may be referred to as the resulting facts and assumptions. The resulting facts and assumptions may also serve as source facts and assumptions within other instances when they are used to generate other facts and assumptions. Similarly, the source facts and assumptions may actually be resulting facts and assumptions in instances where yet other facts and assumptions are used to generate them. In some examples, source facts and assumptions are used within relationships to generate resulting facts and assumptions and the different resulting facts and assumptions can progressively be used multiple times, within other relationships, to generate additional facts and assumptions. We sometimes refer to relationships used in progression to generate resulting facts and assumptions which are subsequently used to generate additional facts and assumptions as relationship chains.

Exposing users to the network of such facts, assumptions, and relationships between the different source and resulting facts and assumptions, while using a hierarchical structure, can cater to users of a range of skill sets. It also caters to users with interest in different types of information or in different parts of an asset. Leveraging web-based tools of browsing and access and incorporating information within links can allow inclusion of such a variety of information without cluttering the content while making it completely transparent.

In different instances of system 100, the output 124 (one of the calculated estimates 122) may be represented by other estimates that are of interest as an output or as a result. Examples of such output elements include an estimate of a range for the intrinsic value of an asset, an estimate of a range for the expected intrinsic value of an asset at a future time, or an estimate of a range for the expected market price of an asset at a future time. Such output elements of interest may sometimes be referred to as the resulting element. Other examples of output elements include estimates of the size of a market for a product or service at a present or a future date and ranges for such estimates. A framework may include multiple resulting or output elements representative of values of more than one asset.

There may be multiple versions of these framework input facts and assumptions 106, 108, 110, 112 corresponding to different available frameworks. Each of these framework inputs can be based on a variety of available information. Well-known principles of finance and asset valuation, expert opinions, established or experimental models, external or in-house research, and similar information all go in to determining what facts and assumptions to use in a framework and how to combine them.

To apply a different framework and arrive at a different estimate of the same intrinsic value 124 and other values of outputs 114, 116, 118, 120, and 122, the system 100 loads other framework inputs 106, 108, 110, and 112. Several example frameworks are discussed below. The raw data 102, heuristics 104, and framework inputs 106, 108, 110, and 112 may be organized into several categories. Some facts may be variables that change over time, automatically or under the control of some entity.

Within the system 100, data (raw data 102, heuristics 104, framework input facts and assumptions 106, 108, 110, 112, output facts and assumptions 114, 116, 118, 120, 122, 124) can be represented as a combination of underlying data and metadata, as shown in FIG. 2B. The underlying data 152 of an item of data 150 may be a formula, an assumption, or any other piece of information. The metadata 154 has four components, the origin 156, use 158, sensitivity 160, and opinions 162. These may be embedded data that exist within the data structure encoding the item of data 150, or they may be rich information linked from other data sources. For example, the use and sensitivity may depend (as described below) on what other facts and assumptions reference or depend on the data. Rather than maintain a list in each item of data of everywhere else that data is used, a relational database may allow the metadata to deliver the appropriate information when needed without storing redundant copies throughout the system. Some items of metadata, for example, opinions, may themselves be data with their own linked metadata.

The origin (also called the basis) 156 of a piece of information, whether fact, assumption, or otherwise, is an identification of where it came from. This could be a simple thing, like “the stock price came from the NYSE,” or it could be an explanation of the calculations used to derive a value. The basis or origin for some facts or estimate could be calculation, measurement, or observation, while others will be derived heuristically. Going in the other direction, we refer to the use 158 of a piece of information when we mean an identification of what will be done with it, i.e., which other facts or estimates depend on it, and how.

Sensitivity 160 is a measure of how significant a fact, an assumption, or an estimate is in a model, that is, how much does a unit change in the fact, assumption or an estimate impact the estimate of output element, or other facts and assumptions that depend on it. Sensitivity also measures how much does a fact, assumption or an estimate change for a unit change in other facts, assumptions, or estimates. The sensitivity of facts and assumptions to other particular facts or assumptions could be part of one or more of the framework inputs 106, 108, 110, or 112, or it could be provided by users as part of the input heuristics 104.

Opinions 162, like facts, may be received as inputs, but are essentially assumptions made by people, as opposed to the assumptions on which the model (we sometimes use the word model to refer to a framework or other analytical tools for making valuations) is based. An opinion that proves to be especially valid or useful could be integrated into the assumptions used by the model. Other opinions may be treated as facts on which the model operates, while others may simply be provided to the user (e.g., as background facts 116) to assist him in making an informed decision.

A common framework used in estimating the values of assets is a discounted cash flow model. Using this model, the value of a company may be evaluated as equal to the present value of cash flows expected from different annual time periods, P1 through Pn. The present value of cash flows expected from a period, Pm, may be obtained by estimating the expected cash flows and discounting them with an average discount factor. The cash flows expected in any period Pm, may in turn be evaluated as the difference between the cash inflows, for example, inflows from revenues expected in that period, and the cash outflows, for example, outflows from costs expected to be incurred in that period. The different contributors of inflows and outflows are suitably adjusted to evaluate the cash components of all the flows. The revenues may further be obtained as a sum of revenues from different divisions, D1 through Dn, each with products PI through Pn. Similarly the costs may be evaluated as those related to different activities of research and development, manufacturing, sales and marketing, distribution, general and administrative expenses, within the divisions, for different products. Some of the cash inflows and outflows are distinguishable at the product level, while others may only be separable at the division level, while still others may only be distinguishable at the level of the particular annual time period, or even the overall asset. In some examples, various parameters related to the value of different parts of an asset are calculated, but the values of the parts themselves are not calculated. Other commonly used frameworks for estimating values of a company include a comparables valuation framework, sum-of-the-parts valuation, economic value added framework. These frameworks are based on commonly known principles of finance, but other unconventional frameworks may also be used.

For a company, many different parameters at the level of a product, a division, a specific operation, or other activity, for example a significant lawsuit that the company might be involved in, influence the value of a company. However, most individuals, including sophisticated investors, may commonly have opinions, interests or understanding only about the parameters relating to a particular product, a division, a lawsuit, or an operation, instead of the entire company. In addition, many individuals may only be interested in certain parameters or events expected to influence the value of the company. Investment vehicles with payoffs explicitly and primarily dependent on parameters related to such a product, division, lawsuit, operation, or events expected to happen in the future, may allow investors to invest in issues they understand and feel most comfortable about, rather than assume risks related to the entire company. It may also allow individuals interested in the entire company, but unwilling to assume risks due to certain products, divisions, lawsuits, operations or events, to hold a position in the entire company and hedge the risk due to the specific products, divisions, lawsuits, operations or events they are uncomfortable with, using such investment vehicles.

Other investment vehicles may be created with payoffs explicitly and primarily linked to more than one of the specific products, divisions, lawsuits, operations or events of a company, and/or across different companies. These investment vehicles may be offered along with transparent, hierarchically structured frameworks for estimating values of the companies, the investment vehicles themselves, and the numerical levels of the parameters. This will allow individuals to efficiently compare their understanding of the underlying issue, the parameter levels estimated, and estimated values of the investment vehicles against the market prices of the investment vehicles and engage in areas of interest to them. Individuals may then feel more comfortable assuming positions to profit from such investment vehicles.

As noted above, some frameworks may use a hierarchical model of a real-world entity (company, commodity, etc.) underlying the asset being evaluated, as shown in FIG. 3A. A hierarchical model for a framework may be structural. For example, a car company 202 has an automotive division 204a and a finance division 204b. The automotive division 204a has an R&D operation 206a and a manufacturing operation 206b. The financing division has a value based on investments 208a, accounts receivable 208b, liabilities 208c, and other features (not shown). The manufacturing operation has a value based on such things as the factories it owns, the cost of operating them, the value of the cars manufactured, and how much profit it makes from selling them. The R&D operation has a value based on the cost of employing engineers, the infrastructure for their research, etc. The values of these components or the parameters that characterize them are combined to find a value of the division, and the values of the divisions are combined to find a value of the company. Values of components may include placeholders, abstract numerical values, or actual or intrinsic values. Some components may not have intrinsic values. How combinations of components' values are defined is the subject of differing opinions among analysts, as is how the estimated value of the company as a whole should relate to its stock price or the price of a bond issued by the company. In some examples, hierarchies are based on financial and accounting metrics that may not correspond directly to real-world entities.

Other hierarchies are possible. As one example, shown in FIG. 3B, a model 220 may relate the value of the company 202's stock to the value of its different products. Thus the company may be divided into its products A₁ 224a through Aₙ 224n. These can be further divided into specific components of manufacturing 226a, research and development, sales, marketing and distribution, needed to generate income. At the lowest level 234 of the hierarchy 220 are facts or basic assumptions 228. Stepping up the hierarchy and combining the values ascribed to these facts and assumptions 228, based on additional facts and assumptions defining the model, the framework assembles an estimate of the company 202's value. The facts and assumptions defining the model along different paths of the hierarchy, may be provided by experts in different areas, for example, the knowledge of an expert in a market for product Aₖ may be combined with that of an expert in market for product Aⱼ.

Once an asset's valuation has been reflected by such a hierarchy, components of the hierarchy can be used to define new assets with values based only on that component of the hierarchy. In effect, assets or components and values of them can all be viewed hierarchically. We sometimes refer to a marketable asset based on a component as a fractional asset. For example, in the framework of FIG. 3B, a fractional asset may be created based only on the product Aₖ. The value of this fractional asset may depend on the present value of future cash flows expected from such a product. In some examples, the fractional asset is basically a derivative contract defined on some parameters that influence an asset. More specifically, the value of such a fractional asset may depend on the current and future market demand for the product, its cost of production, and the ultimate decision on an ongoing lawsuit against the intellectual property on such product. A potential investor who is familiar with such issues, but unfamiliar with other aspects or products of the company's business, may be comfortable investing in such a fractional asset based on his own evaluation of the underlying factors and a comparison of his evaluation to the model used in the framework, but would not be willing to invest in the company as a whole. Such fractional assets can be created at any level of the hierarchy, and tracking the real prices at which such fractional assets are traded can further refine the overall model. Providing such fractional assets allows a far broader class of investors to participate in a much more subtle, rich, diverse, and comprehensive set of markets. The components themselves on which fractional assets are based may not have clear values. When we refer to fractional assets, we sometimes are actually describing a contract on the outcome of an event pertaining to the asset.

In some examples, as shown in FIG. 3C, fractional assets spanning different top level assets may be combined to create additional new asset types. For example, the product A₂ fractional asset may be combined with a product B₁ fractional asset for other products in the same market, produced by different companies, e.g., CompanyB 242 in FIG. 3C, to create an aggregate fractional asset 250 with a value 250a derived from the values 230b, 240a of the fractional assets it combines. Such an asset 250 could have its own selection of hierarchical models, for example, one divided first by company and another divided first by geographic region where the constituent products 224b and 244a are sold. Fractional assets may also span categories within a single top-level asset, for example, a fractional asset may be based on all products in developmental phase for all the divisions of a company.

A comprehensive system to gather, analyze, and provide this information will also facilitate creating markets in which contracts for such fractional assets can be traded. As shown in FIG. 2C, participants using the information made available from the system 100 through a user interface 176 can be directed by that interface to the appropriate markets, e.g., a market 170 where they can buy and sell fractional assets 172, and the trades 174 taking place on the market 170 can feed back into the system 100 as new input facts and to provide improved assumptions for the frameworks. The user interface is discussed in detail below.

Various techniques can be used to increase the transparency of the data available to potential investors and other interested parties.

In some examples, as shown in FIG. 4, an interactive interface allows the user to explore the hierarchy, facts, assumptions, relationships, and relationship chains of a particular framework. As the user clicks on an element at one displayed tier or portion of the hierarchy, the elements at the next tier down or another portion that explain that element are shown. In the example of FIG. 4, a user interface 300 is shown displaying attributes of a company called Alkermes. The company name 302 is shown at the top of the display. Three different frameworks (referred to as Asset Value Estimates 304 in the user interface of this example) are offered for this company: Sum of parts of the company 306a, Discounted cash flow 306b, and Comparables 306c. In this case, the user has selected the Sum of parts framework 306a, so the hierarchy 308 of that framework is shown. The top level of components are product lines 308a-n. The user has selected Risperdal Consta (one of Alkermes's products) 308a, so the elements that this framework 304a uses to estimate a value of a product, its value in each of several years, are shown as the components 310a-n at the next level 310 of the hierarchy. In turn, one of these components 310a has been expanded to show one sub component 312a at the next level 312, and that has been expanded to three deeper levels 314, 316, and 318 of the hierarchy. Separate from the frameworks, other features 320a-d are displayed at the bottom of the interface. Contracts 320a links to the contracts market described above.

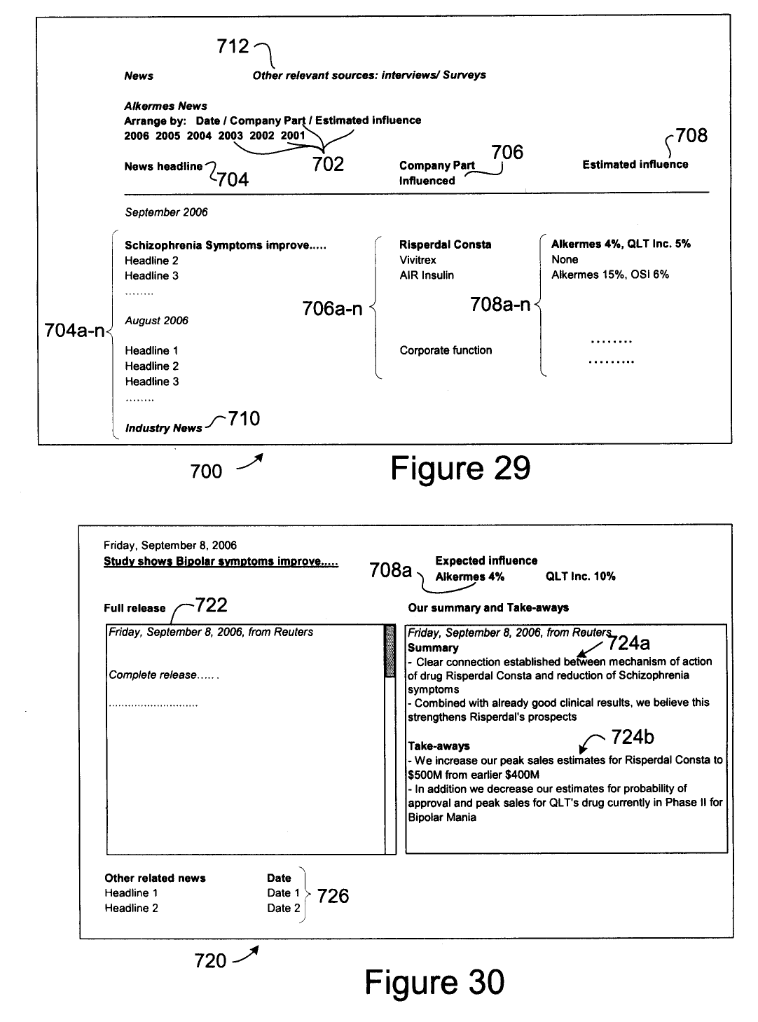

In some examples, as shown in FIGS. 29-32 and discussed below, news releases and other information releases including interviews, surveys, conducted internally or externally, can be gathered and analyzed to find information relevant to asset valuation at all levels of the frameworks. These can be linked to by the news link 320b in the interface 300 of FIG. 4. This news can be delivered to the users, annotated to show what effect the models predict it will have on any relevant part of affected assets or the entire asset. This could include identifying fractional asset contracts that can be expected to gain or lose value as a result of the news, and links to other relevant information.

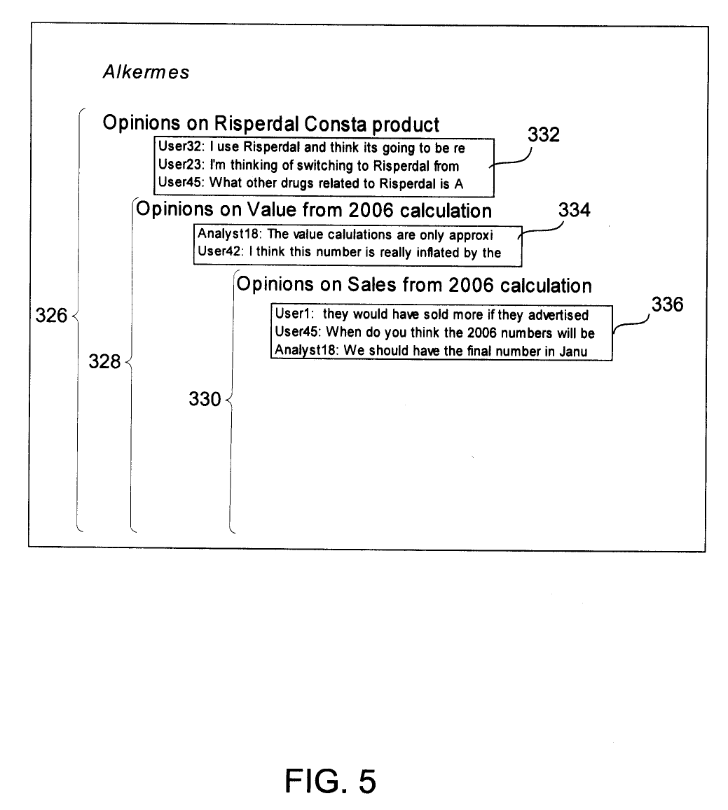

The “Your Opinion” link 320c may take users to an interactive forum. Many web sites have forums that allow participants to discuss topics of interest. For investments, forums may be focused on particular stocks or particular classes of investments. This concept can be extended to all levels of the system described here, providing a network of forums following the same structure as the hierarchies underlying the frameworks, as shown in FIG. 5. At each level 326, 328, 330, the discussion 332, 334, 336 can be focused on just the component considered at that level, and participants can discuss the relationships, calculations, facts and assumptions used. The system can automatically filter, divide, and combine the discussions to provide relevant discussion and opinions at each level, even in overlapping hierarchies. This allows a first participant to take part in a discussion narrowly tailored to his expertise, while allowing participants at other levels to see comments by the first participant relevant to their chosen level, as selected by the system. Such a forum allowing discussion at different levels of the hierarchy, with an automatic capability for filtering, division, and combination, may allow such discussions to be more meaningful than unstructured or non-hierarchical discussions involving broad generalities offered without useful and reasonable rationale. Discussions with substantiation and rationale may also draw a larger audience and over time continue to grow in attractiveness to a larger population.

To further provide transparency, when viewing a comment or opinion, a user can also see why the system selected that comment or opinion for inclusion in the forum at the present level—that is, the origin metadata for the opinion, as mentioned above. The community facilitated by such a forum will benefit from increased participation—as more people participate, the quality of information will increase, and even more users will be drawn in.

Additional benefits can be achieved by employing in-house research analysts (in-house with respect to the party that creates, operates, or manages the platform) to aid the discussion, steering it in positive directions, and answering questions posed by participants. The in-house research analyst can also benefit from such forums as they can use the information exchange to refine the facts, assumptions, calculations and judgment used in estimating the intrinsic value of assets, thus making it more attractive for users. To enable efficient analysis of ongoing discussion at different levels, the analyst (we sometimes use the term analysts as one example of a moderator of the platform) can cause the discussion to be fed through a program that helps arrange the different discussions based on hierarchy, topic, or the expected skill level of the users. In addition, monitoring the discussion can allow identification of users who may engage in disruptive behavior on the platform and taking steps to prevent damage or future participation of such users.

As data is evaluated though the various frameworks, the system may be configured to identify some facts as interesting to likely users. The user can reach this from the “Amazing Facts” link 320d in the main interface 300. These facts may include, for example, news articles, changes in analysts' ratings, or product announcements. Such facts can be highlighted when the user accesses the system and linked back to the source material, including an identification of why the fact was highlighted and what effect it has on the model.

A platform for communicating asset value or future price estimates can be built by combining transparent, hierarchical, interactive frameworks with quality research. Such a platform may provide a solid backbone of information that users may be able to understand and discuss freely with other users at a meaningful level of facts and assumptions within products, markets, events, and topics of interest, within assets, and across assets. Users may be provided an option to modify the content to incorporate their own views and share them with others, to make the platform more attractive. In some examples, users are not allowed to modify elements of the body of information, or user modifications must be authorized by a controlling authority.

Another part of the platform, may include popular content such as ‘Amazing facts,’ ‘Your opinion,’ and commoditized content of broad interest such as market data, news feeds, and personal finance sections that may allow users to feed their interest in asset parts (products, markets, operations) or events by reading about them in a structured framework, within different relevant contexts. Through contracts users may actually be able to act on their views on asset parts or events of interest. Users may also be able to additionally branch off into understanding, participating in, and acting on other aspects of an asset or other related assets.

In another part, different news stories that may be categorized within topics, companies, products, markets, or events of expected interest to users, is expected to act as a hook for a large base of users. Estimates of impact of assets influenced by a news event may be provided along with the news to attract users to read the complete ‘impact story’ along with the news story. The news with impact may be linked with estimates, frameworks, and contracts for additional usefulness.

Using these different sections of interlinked content, a unique, meaningful, online financial community can be organized for sharing and trading views on financial assets. Offering parts like ‘interesting facts,’ ‘your opinion,’ and ‘news with impact’ well-integrated with the asset value estimates, and contracts, may appeal to a broad range of users. Users may be attracted initially to sections of direct interest to them and may also be able to transition smoothly to other sections outside of their current familiarity and financial sophistication. As a result, they may be able to develop familiarity, interest, or comfort to understand content within such sections and participate more actively in them, for example, through discussions and contracts. Combining best-in-class research with content that may be accessible free of charge may allow and encourage broad involvement. Such a financial community may appeal to users with a broad range of financial sophistication. Interlinking the different types of content and presenting users with different contexts may be implemented to allow users to transition smoothly between different sections, increasing the appeal. Constant refinement of the content, structure, framework, functionalities, contracts, and advertisements of the platform, using data on user activity and from user surveys, may be used to update or improve the usefulness of platform to users. Data on user activity on the transparent valuation market can also be collected and analyzed to identify the traffic drivers and refine the marketing, publicity content, and efforts to attract additional users to the transparent valuation market.

Different sections of the content, including the asset value estimates, facts, and assumptions, may be updated by the experts over time as new and relevant facts and information become available. This is expected to help users better study, discuss, and use the body of information. The updating may be done continuously as information becomes available, and some of it may happen automatically through data received from electronic feeds. When updating the content, the older information may also be stored and made available to users for reference.

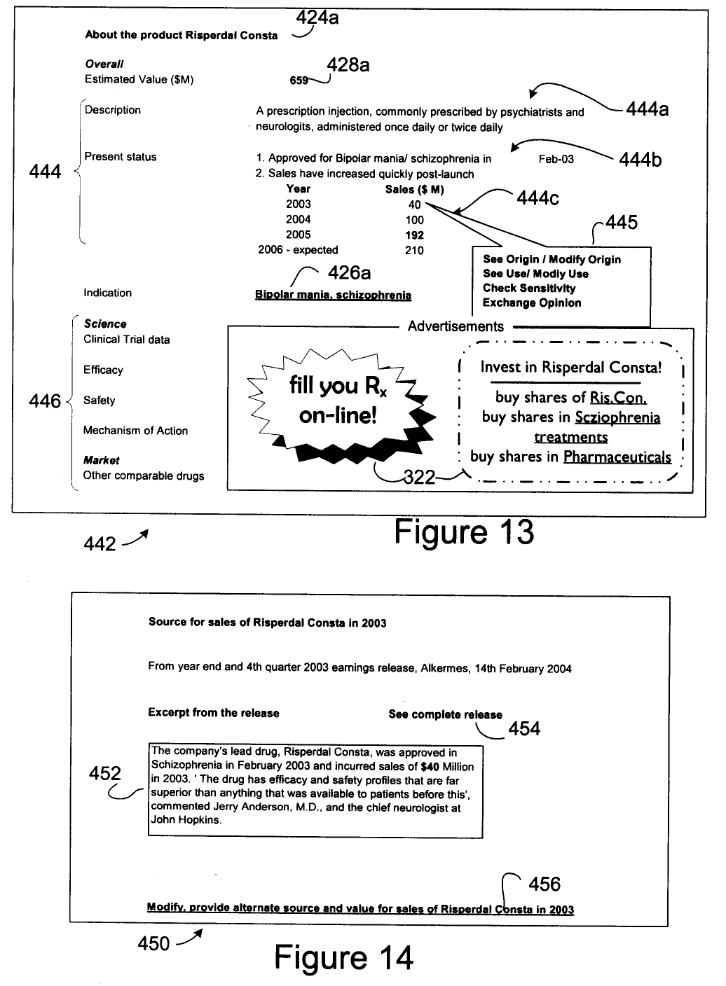

Advertising can serve as both a source of revenue and as additional information for the models and platform. Advertisements for products and services can be narrowly tailored for the specific components of an asset's value, according to a particular model, that a user is looking at, and can direct a user to investment opportunities focused on that area. See, for example, the sample advertisements 322 in FIG. 13. The success of such advertisements can be fed back to the model to evaluate the value of the advertised service and the relevance of the information with which the advertisement was associated, among other things.

### Participants in the Transparent Valuation Market

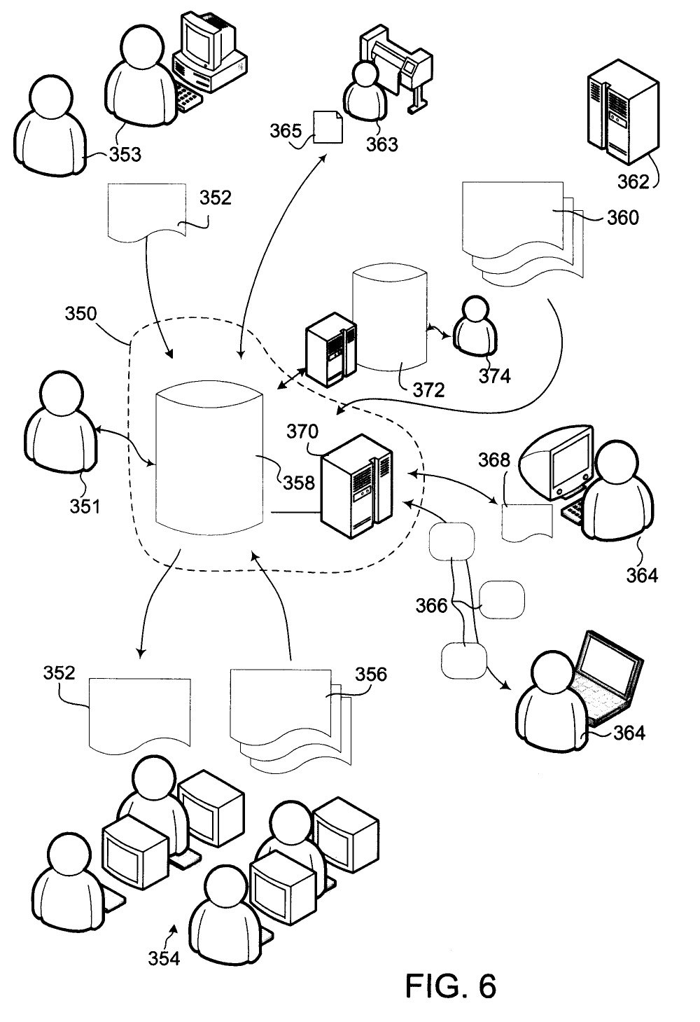

The overall operation of a transparent valuation market that can be created with such a detailed body of information is shown in FIG. 6. Various individuals and entities can be involved in creating, maintaining, and using such a transparent valuation market. The computer system 350 underlying the transparent valuation market is operated by one or more operators 351 or host. The frameworks used to estimate asset values based on the available facts and assumptions are formulated by market and financial experts and others with experience in the needed analysis, as selected by the operator 351, and may also be based on commonly known concepts for asset valuation and principles of finance. Other experts within the transparent valuation market may include experts in design or development of information on the communication medium, who may work in close collaboration with experts in finance, markets, and other experts. An electronic data interface may enable interaction of the financial experts with the experts in design or development of information.

In some examples, general frameworks 352 broadly describing how the available facts correspond to the parts of a hierarchy and how they relate within the hierarchy (the assumptions) are assembled by a first group of analysts 353, who may provide some example frameworks applied to specific assets. A second group 354 of analysts then can use this framework 352 to develop similar frameworks 356 for other assets.

For example, an expert 353 in analysis of pharmaceutical company stocks may create a general framework for estimating the value of stock of a pharmaceutical company and a specific framework applying that general framework to a first pharmaceutical company. These model frameworks 352 are then provided to a team of researchers 354 who create a similar framework 356 for valuing stocks for each of the other pharmaceutical companies to which such a framework may apply. Experts 354 may additionally be supported by another set of experts (not shown) who may primarily be engaged in data collection and the first level of analysis.

As another example, an expert 353 in investment banking may create a general framework for estimating the value of bonds issued by an investment bank and a specific framework applying that general framework to a first bank. These model frameworks 352 are then provided to a team of researchers 354 who create a similar framework 356 for each other bank that issues bonds on the relevant market. All the frameworks are stored in a central database 358 controlled by a server 370 which implements the system 100 (FIG. 2B) and makes the analysis available to users.

The operator 351 of the transparent valuation market may purchase commercial content 360—news feeds, market reports, expert analysis, frameworks for estimating asset values—to integrate into the system according to the frameworks 352, 356 developed by its own experts 353, 354. The providers 362 of this content 360 may simply treat their product as a commodity, charging flat prices for their goods regardless of their use, or they may negotiate more sophisticated arrangements, such as sharing revenues generated by advertising published on the same web pages as their content. The system 350 may also output data back to external providers 362 to include on whatever sites they operate. The operator 351 may also arrange with an advertiser 363 to provide advertisements 365. Advertisements may serve as both a source of revenue and as an additional information source, as described in more detail below. Advertisers may also be interested in the data collected from user activity and user surveys to help improve the usefulness of advertisements.

End users 364 of the system may serve multiple roles—beyond viewing advertisements 365, and viewing, buying and selling, or bidding on whatever contracts, investments, other content, or services 366 are offered, advertised, or linked to by the transparent valuation market, users may contribute inputs 368 in the form of their own opinions entered into discussion forums or other feedback systems. Through the discussion links or through answers to stand-alone or questionnaires, users may also be able to offer suggestions for offering of new contracts that may be of interest to them. Users also provide information through their usage habits, which can be monitored by the system 350. Such data can be analyzed to refine understanding of user needs and to improvise the content and frameworks, increasing their appeal for the users. Such data can also be analyzed to better understand user response to advertising and improving the usefulness of advertising to both users and advertisers. Data on user activity and surveys may also be of interest to third parties and the operator 351 may share such information with the third parties with or without charges.

A market for contracts on fractional assets may be operated on a separate system 372 or it may be integrated into the transparent valuation market system 350. Market makers 374 who provide liquidity for the contracts market will be essential participants. In some examples, the contract market is directly integrated with the transparent valuation market and its backers 374 will work closely with the operators 351 of the transparent valuation market. In other cases, the two operate independently, with the transparent valuation market referring customers 364 to the contract market in exchange for commissions and information about their participation. Certain other legal or regulatory experts may be involved either in-house within the transparent valuation market or externally to provide expert advice on contracts or other parts of the market.

The transparent valuation market system 350 may be hosted somewhere on a network. In some examples, standard internet hosting technology is used. This could be provided by a third-party vendor or could be operated in-house by the operator 351 using a direct connection to the internet. Proprietary networks could also be used, in some examples overlaid on an existing information infrastructure but separated from the other content communicated on it.

Advertisers may participate through a variety of models. Some advertisers may simply purchase advertising space on the information pages for certain assets, while others may wish to be more integrated, basing their advertisements on usage patterns and detailed relationships between pieces of information, receiving feedback from which they can refine their own models and providing similarly valuable information to the market operators.

The Database that Underlies the System

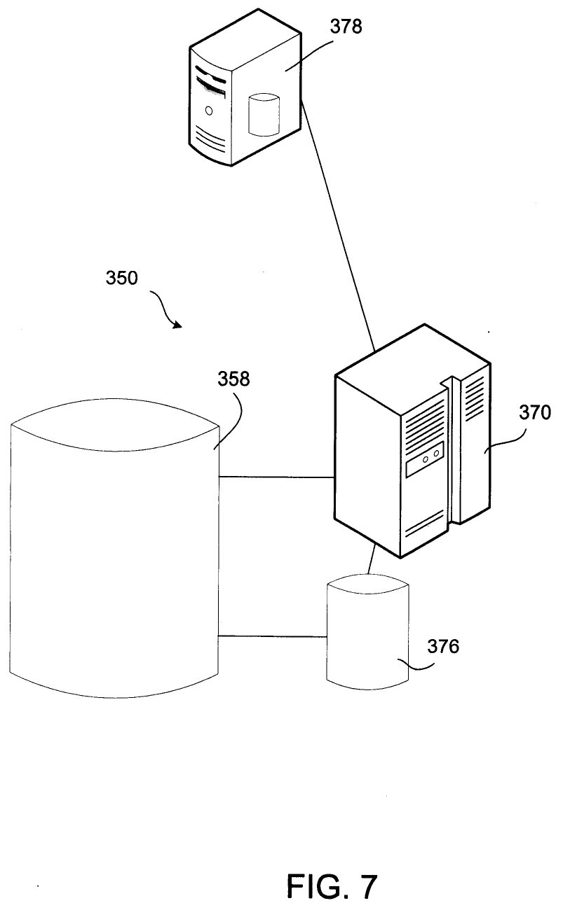

The database 358 used to store the frameworks and data may be implemented as shown in FIG. 7. As noted above, a framework is not a single piece of information but is, for example, a collection of facts, assumptions, relationships, and relationship chains, some of which are calculations to be performed on other facts and assumptions, on input data, or on the output of other calculations. All the facts and assumptions in a given framework may be stored in a single database 358. This could be, for example, a massive table or a set of relational databases. The data could be spread among a variety of separate database systems, e.g., 358, 378. In some examples, each framework is a unique set of data, while in others, a framework is metadata representing a selection of facts and assumptions from other sources and to be retrieved as needed. These different examples are not mutually exclusive, and different features from different database implementations may be mixed and combined as needed to provide the robustness and transparency needed to operate the transparent valuation market.

In some examples, a server 370 with which users 364 interact maintains a store 376 of content that is regularly updated from a master database, e.g., the database 358. In some examples, the server 370 provides direct access to at least a subset of the data in the master database 358. The master database 358 can contain the raw data that is available to users 364 and to the frameworks, definitions of the frameworks themselves, including assumptions, facts, and relationships that are part of each framework, the current values calculated for any of the outputs or intermediate values produced by the frameworks, and additional information useful to its operators 351 to maintain the entire system 350. The information contained in the master database 358 may come from a variety of sources, and what we describe as a master database may, in some examples, be a set of databases linked together by information contained in one or more of those databases or in another location. In addition to the data directly used in the frameworks, the master database or a secondary database may store additional information such as user profiles and development tools for the analysts 353, 354 generating frameworks.

Information about assets could be collected from the markets on which they are traded, gathered from websites or through interviews with experts, or generated by analysts, to name a few examples. This information may be purchased by the maintainer of the database or it may be gathered from free sources. Whether and how much the maintainer paid for the data may also constitute additional data on which the frameworks can base valuations, but business agreements may prevent disclosure of that information. Metadata for a given fact, within a chosen framework, may indicate its origin, how it is used within that framework or calculations within the framework, how sensitive other facts and assumptions are to that fact, how sensitive the fact is to other facts within that framework, and links to other metadata about the fact, such as user opinions related to it. Similarly, metadata for a given assumption, within a chosen framework, may indicate its origin, how it is used within that framework or calculations within the framework, how sensitive other facts and assumptions are to that assumption, and how sensitive the assumption is to other facts and assumptions, and links to other metadata about the assumption, such as user opinions related to it. Each of these elements of a record may be directly stored with the fact or the assumption or may be linked to the fact or assumption through other parts of the master database, such as the framework definitions. Any standard approach to database architecture could be used to construct and maintain the database, depending on the actual implementation.

The master database may be housed at a central location or may be distributed according to any database topology. To assure transparency of the information provided, it may be beneficial for the database to be maintained by the same entity that provides the interface to the information, but other arrangements are possible.

Changes to the database—additions, deletions, edits, restructuring, etc.—are carefully managed and documented. This serves several purposes. As noted for other features, it enhances the transparency of the data and can itself serve as an input to frameworks. For example, an evaluation of stock price may consider how recently the underlying data were changed, and may find it more efficient to get that from the database's metadata than from the raw data itself.

The in-house analysts will perform the valuation of assets with data retrieved from the first database 358 and the outputs stored there. Web-designers and system developers will have to access this data and ensure conversion to a format suitable for publication on the web and suitable arrangement on multiple web pages. An intermediate system program may convert the relevant content for estimates of asset value from the format generated by the frameworks to a format that is easier for web designers to use, to ultimately publish it online. In-house analysts may work closely with web-designers, system developers, and IT personnel to ensure the content has appropriate format and desired usefulness.

### The User Interface

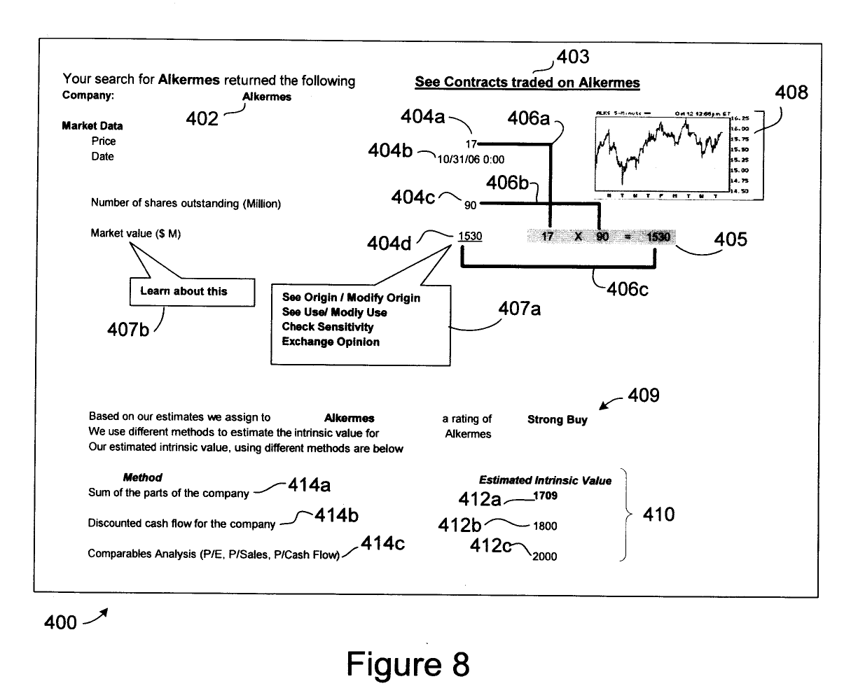

In some examples, the user interface for the platform is as shown in FIGS. 8-32. The information displayed in the user interface corresponds to framework parts or elements including the framework inputs 102, 104, 106, 108, 110, and 112, framework outputs 114, 116, 118, 120, and 122, and calculations 130, 132, 134, 136, and 138 in the system 100 of FIG. 2A. This information may come directly from the databases 358 discussed above or may be retrieved from other sources based on links to it found in the framework outputs. Some of the information, for example, advertisements, that is not directly part of the frameworks may also be loaded from sources external to the transparent valuation system. In some examples, any item of information displayed in the user interface is connected, for example, by hyper linking, to related information including its origin, its use, and other metadata. The extent to which this is applied to every object in the interface may depend on the resources of the computer systems supporting it and those developing the system.

FIG. 8 shows a home page 400 for a particular asset, identified by its name 402 at the top of the page. In this example, the asset is a publicly traded company, so the page includes market data such as the stock price 404a, when that price was last updated 404b, the number of outstanding shares 404c (in millions, in this example), and the market value 404d. As one example of the transparency of information in the transparent valuation market, when the user positions a mouse cursor over the computed value 404d or when he clicks on that value, a pop-up menu 407a appears. On clicking the ‘See Origin/Modify Origin’ link within the pop-up menu 407a, a box 405 appears along with lines 406a-c indicating how the market value 404d was calculated from the stock price 404a and the number of outstanding shares 404c, and illustrated by lines 406a-c. The pop-up menu has additional links, including ‘See Use/Modify Use,’ ‘Check Sensitivity’ and ‘Exchange Opinion.’ By selecting these respective links the user is offered additional relevant options, similar to those explained elsewhere. Another pop-up menu 407b appears when the user positions a mouse cursor over the term ‘Market Value’ or when he clicks on the term. The menu 407b includes a link ‘Learn about this,’ which the user can select to be transferred to another screen showing the explanation of the term. Similar pop-up menus can be provided for any data in any of the user interface screens, but may not be shown in each figure below.

Other information in the asset home page 400 includes a graph 408 of recent stock performance and a rating summary 409. In this example, the summary 409 indicates that the in-house analyst has assigned a rating of “strong buy” to the asset. Clicking on that rating could bring up an explanation of how that rating was computed. In some examples, as here, part of that explanation is provided up-front, in the indication 410 of estimated intrinsic values 412a-c computed by three different frameworks 414a-c, respectively.

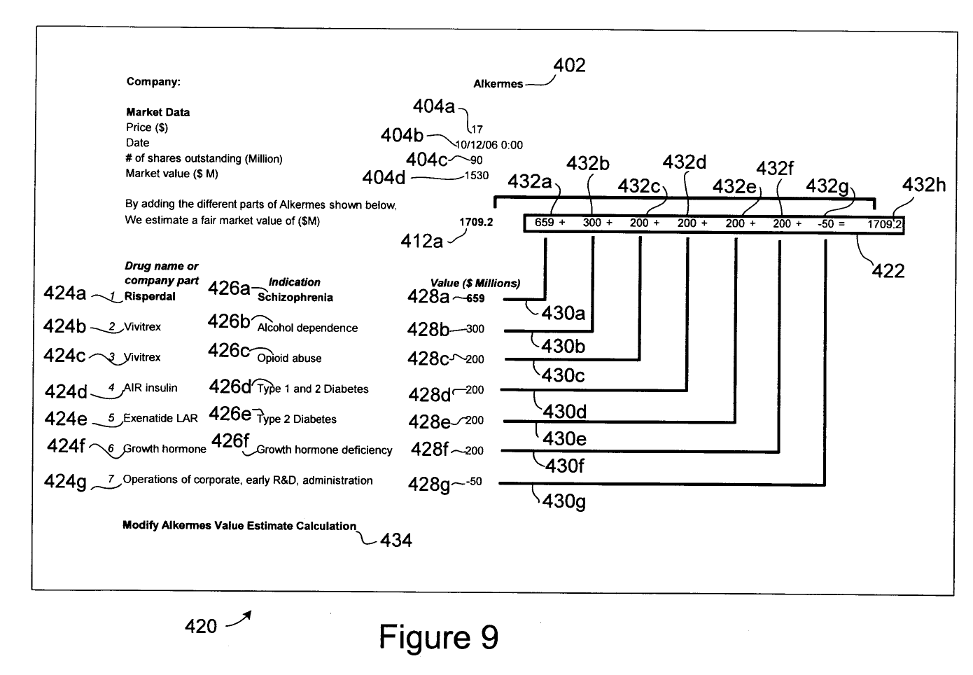

The user sees a similar pop-up menu (not shown here) as 407a when the user positions the mouse cursor over or clicks on any the computed values 412a, b, or c. By selecting the ‘See origin/Modify Origin’ link within any pop-up menu (not shown here), the user is shown the origin of the computed value. Unlike the computed value 404d that was computed with information 404a and 404c that was shown on the same screen 400, the information from which the estimated intrinsic values 412a, b, or c is computed is displayed on a different screen where it can be explained in greater depth. Upon selecting this option for the sum of the parts value 412a, for example, the user is taken to a second screen 420 in FIG. 9 displaying the origin of the computed value 412a. In this example, this is the calculation 422 immediately preceding the computed value 412a in the hierarchy of the framework. This calculation shows how the value 412a was calculated. In the screen 420, some information is repeated from the home screen 400, such as the stock price 404a, the time it was last updated 404b, the number of outstanding shares 404c, and the market value 404d. The fair market value 412a computed by the present framework is shown with the indication 422 of how it was calculated. We sometimes refer to the intrinsic value as the fair market value of the asset.

For this framework, the company is hierarchically decomposed into components 424a-g, some of which correspond to products—in this example, drugs. Because the company being displayed produces pharmaceuticals, the version of the “Sum of the parts” framework for this company considers the indications for the company's drugs to be a relevant fact, so that is included and the user can find related information by clicking on any of the listed drugs 424a-f, indications 426a-f, or their values 428a-f to the company. Other operations of the company make up a seventh component 424g with a value 428g. Lines 430a-g connect each value 428a-g and the output 412a to the corresponding element 432a-h in the computation 422. The lines could be differentiated using different patterns or colors in order to further enhance the clarity or visual appeal of the display.

A link 434 at the bottom of the page allows the user to edit the calculation, for example, if the user is familiar with this company or its industry and thinks that one of the drugs 424a-f is too risky and should not be included in the estimate of the intrinsic value, they can remove it from the calculation. Such a link can be provided on any page that includes a calculation. A similar link (not shown) may allow a user to modify facts or assumptions that are not calculated but are derived from any given source.

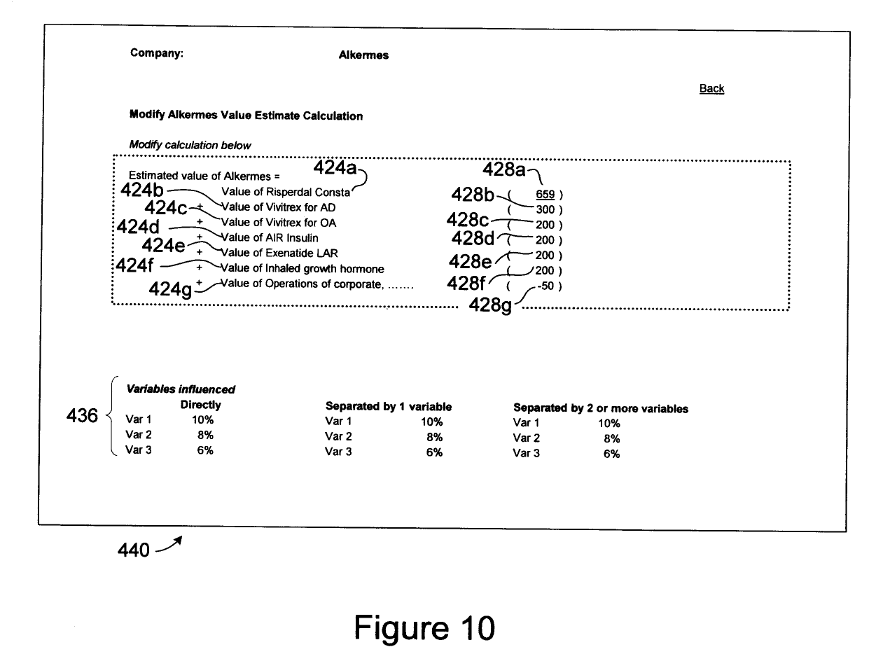

Additional screens, such as those shown in FIGS. 10-33, may present additional details about each element in the first two screens 400 and 420. These are discussed briefly, and it should be understood that the specific facts shown, highlighted, and explained in these screens may be specific to the particular type of asset, stock in a pharmaceutical company, used for this example. Similar screens detailing different information may be used for other types of assets and other types of companies. 101221 Once the user modifies a calculation, or any other part of content, there is an option to save his work, once he logs-in to his account. In addition, the user has an option to switch back to his saved version or the default version for the estimate of asset value. He can also make his saved versions available for sharing with friends or colleagues.

The link 434 from the detail screen 420 allows the user to change how the value is estimated within the present framework. This link leads to a screen 440 in FIG. 10. Here, each of the components 424a-g is listed with their corresponding values 428a-g. The user can add or remove components 424a-g. The user can also alter any of the mathematical operations (here the summation operators). In addition, the user can follow links from each of the values 428a-g to explore or modify how the individual values 428a-g are calculated. An array 436 of variables influenced shows the user what other variables will be affected by the changes he has made, and by how much.

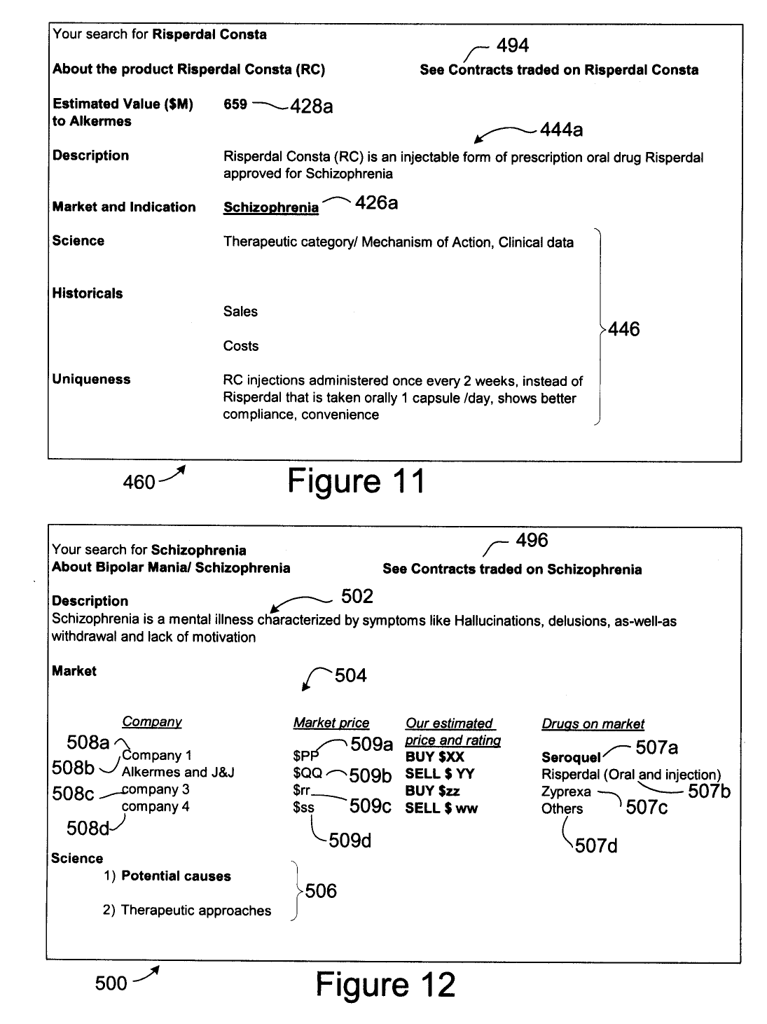

In screen 420 (FIG. 9), each of the drugs 424a-f or their indications 426a-f could link to additional information about those items, as shown in screens 460 and 500, in FIGS. 11 and 12, respectively. These screens could also be reached by searching within the content of the platform specifically on the corresponding drug (Risperdal in FIG. 11) or symptom (Schizophrenia in FIG. 12) rather than through information about the company that makes the drug. In screen 460, the value 428a of Risperdal Consta to Alkermes is shown—if other companies also produced this product, its value to each could be included. The indication 426a is also shown again, and links to the Schizophrenia search results screen 500 in FIG. 12. Additional information 446 such as scientific and market information is provided, and this could also link to additional screens (not shown). A link 494 offers contracts traded specifically on the Risperdal Consta product. In screen 500, information about Schizophrenia is displayed, including a description 502, information 504 about the market, and scientific information 506. The market information 504 includes an identification of drugs 507a-d used to treat the disease, companies 508a-d that produce them, and the market prices 509a-d of those companies. The identifications 508b of Alkermes and 507b of Risperdal link to the corresponding screens 400 and 460 already discussed. A link 496 offers contracts related to Schizophrenia (e.g., contracts on multiple drugs related to the disease or companies that produce them).

In FIG. 13, further details about Risperdal Consta (FIG. 11), are shown in another screen 442. This screen could be reached from the calculation modification screen 440, the value detail screen 420, or the search results screen 500, depending on the implementation and the user's actions. In this screen, the estimated value 428a is repeated, and a description 444 of the product 424a including its use 444a, approval status 444b, and sales FIGS. 444c are shown. The indication 426a is also repeated. Each of the sales FIGS. 444c in turn links to a more-detailed screen, such as screen 450 in FIG. 14, which includes an excerpt 452 of an earnings release, a link 454 to the complete release, and a second link 456 to edit the source. This may be controlled through a pop-up menu 445 like the menu 407a shown in FIG. 8. The indication 426a again links to a detail screen 500 in FIG. 12. Additional information 446 such as scientific and market information is again provided, and again could link to additional screens (not shown).

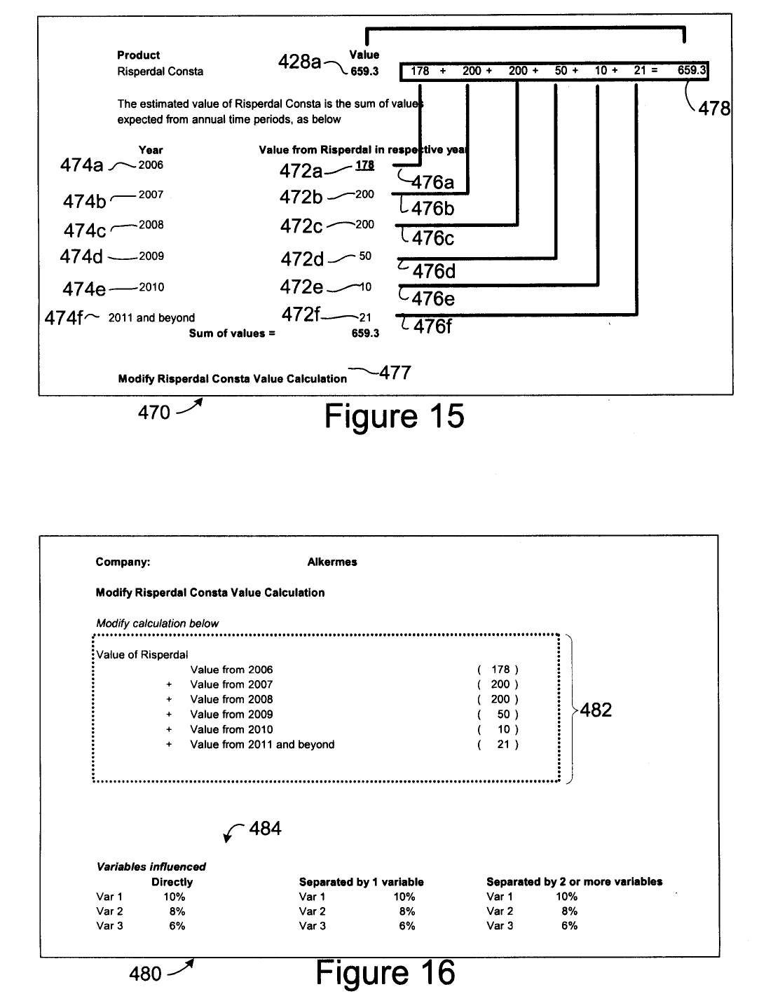

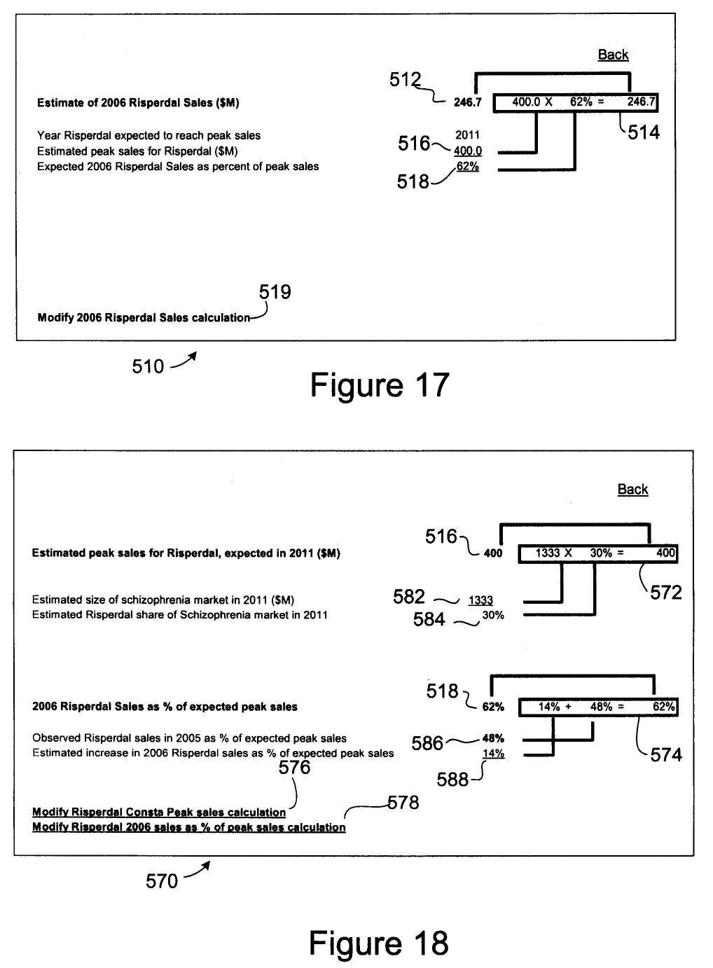

The estimated value 428a of the current component in each of screens 420, 440, 442, and 460 links to another computation detail screen 470 in FIG. 15 showing how that value was determined. In this case, the value is the sum of value estimates 472a-f from the current (474a) and several upcoming years 474b-f, again linked by lines 476a-f to a computation box 478, which shows how the total 428a is computed. As with the other computations, a user can follow links to modify the computation (screen 480, FIG. 16—link 477), see where the value for one year, e.g., value 472a for year 474a, was computed, and see how details within that year were calculated and interrelate (e.g., screen 510, FIG. 17).

In screen 480 (FIG. 16), the value 482 of Risperdal from each of several years is displayed and can be modified. A table 484 displays which variables (named Var1-Var3 in this example) are affected by changes in the overall value of Risperdal, and by how much. Screen 510 (FIG. 17) shows how the estimated sales of Risperdal in 2006 are calculated. This may, for example, be a component of the value 482 shown in screen 480. Screen 510 shows how the computed value 512 is derived using the calculation 514, detailing how the expected peak sales 516 and expected 2006 sales 518 are combined to produce the estimated 2006 sales. This calculation, like any other, can be modified by clicking on a link 519.

Screen 570 (FIG. 18) allows the user to view and modify the values 516 and 518 used in screen 510. Calculations 572 and 574 show how each of these values is calculated from underlying values 582, 584, 586, and 588. This screen 570 includes links 576, 578 to additional screens (not shown here), similar to screens 440 and 480, in FIGS. 10 and 16, respectively. On such screens a user can examine and ultimately modify the specific calculations.

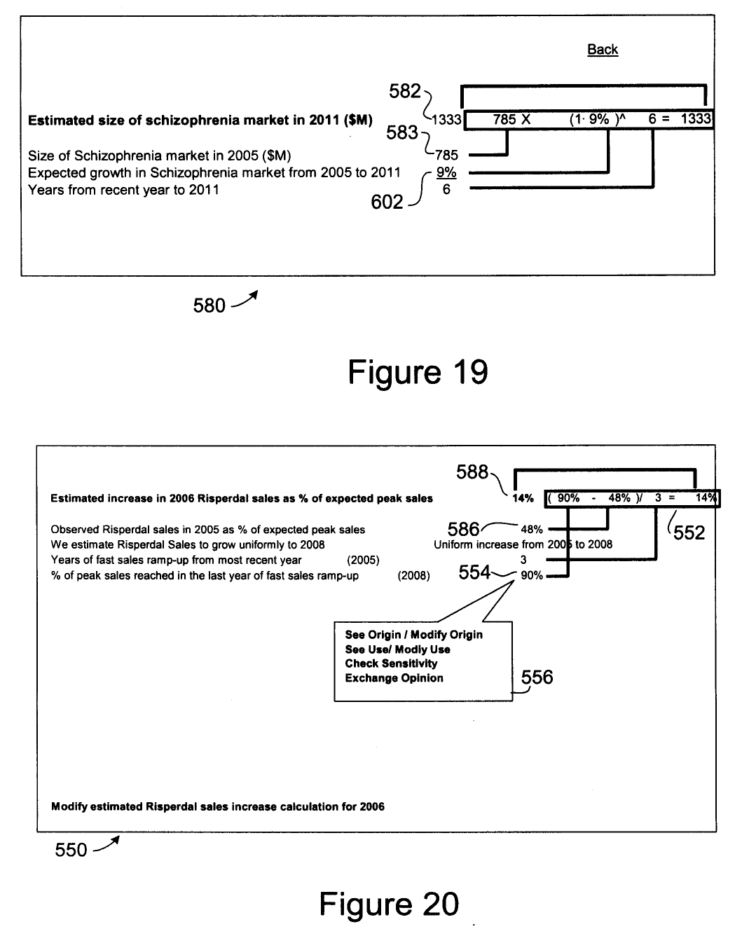

When a user positions the mouse cursor, or clicks on the computed value 582, a pop-up menu similar to 407a appears (not shown). By selecting a ‘See Origin/Modify Origin’ link within the pop-up menu, the user is taken to screen 580, in FIG. 19 showing how the size of the schizophrenia market 582 in 2011 is computed from the size 583 of the market in 2005 and the annual growth rate 602 expected from years 2005 to 2011. Similarly, choosing to view or edit the origin of the computed value 588 on screen 570 takes the user to screen 550, in FIG. 20, showing the computation for the estimated increase in 2006 Risperdal sales as a percentage of expected peak sales.

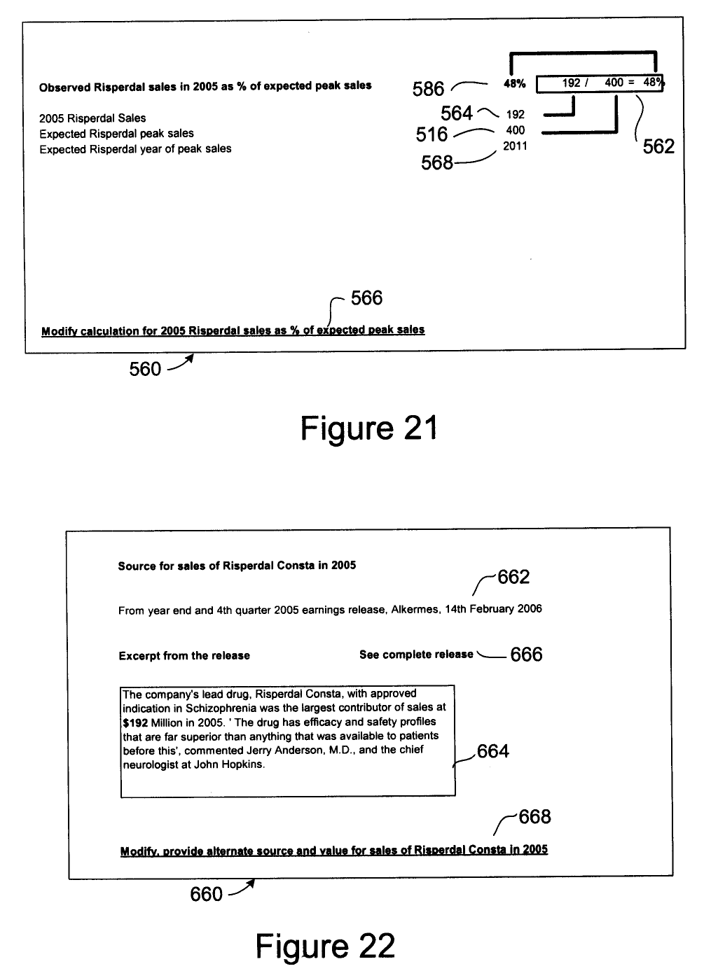

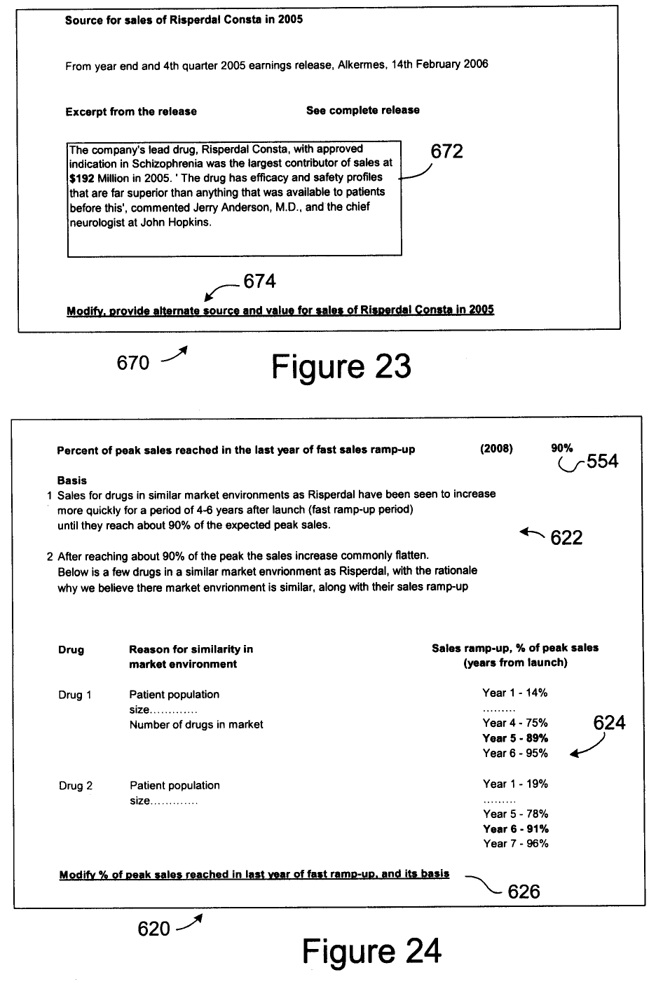

Screen 550 in FIG. 20, shows how the estimated increase 588 in 2006 sales is computed. Equation 552 combines the value 586 of 2005 Risperdal sales as a percentage of peak sales, repeated from screen 570 (FIG. 18), with the percentage 554 of peak sales expected to be reached in the last year of fast sales ramp up. The value 586 links in turn to screen 560, in FIG. 21, showing its computation 562 from 2005 sales 564 and expected peak sales 516. A link 566 allows the user to modify the computation 562. The 2005 Risperdal Sales 564 in screen 560 links to screen 660 in FIG. 22. Screen 660 shows the user the source 662 of the Risperdal Sales in year 2005 and includes an excerpt 664 from an earnings release, a link 666 to the complete release, and a link 668 to another screen 670, FIG. 23, that displays the source material 672 for the Risperdal Sales in 2005 and allows the user to edit it through a link 674. Note that screen 560 would also link back to screen 570, as the computation 562 uses as an input the output 516 from the computation 572 in screen 570.

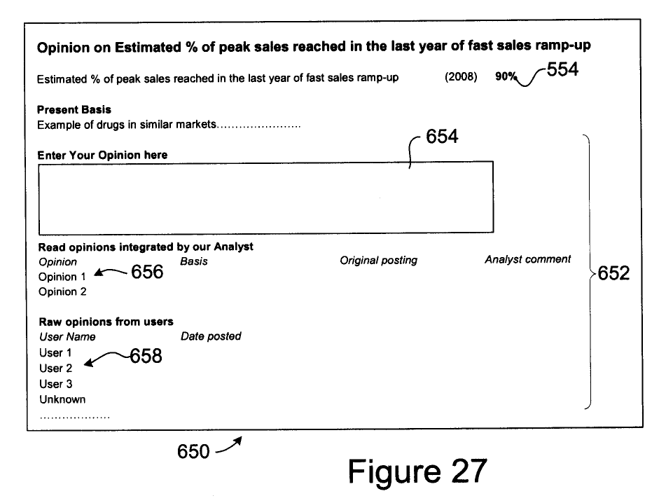

Also in screen 550, the percentage 554 of peak sales reached in the last year of fast sales ramp-up has associated with it a pop-up menu 556 similar to the menu 407a discussed above. Selecting the ‘See Origin/Modify Origin’ option within the menu 556 takes the user to screen 620, in FIG. 24. Selecting the ‘Check sensitivity’ option within the menu takes the user to screen 630, in FIG. 26, and selecting the ‘Exchange opinion’ option takes the user to screen 650, in FIG. 27 where a user can see opinions 652 entered by others regarding one of the details in the preceding screens.

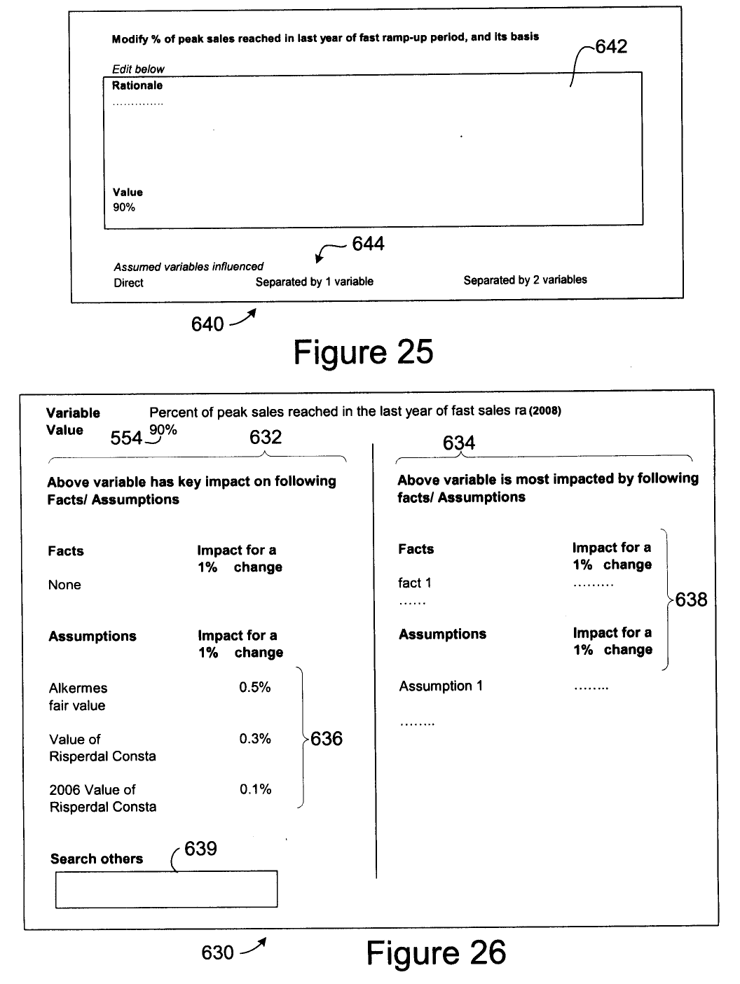

In screen 620, there is the indication 554 of the percent of expected peak sales reached in the last year of fast sales ramp-up and an indication 622 of the basis for this number including, in this example, a table 624 of how similar drugs performed. The link 626 links to screen 640, in FIG. 25, providing the user an option 642 to modify the basis 622 described in screen 620 and showing the effects 644 of such a modification.

In screen 630, key facts and assumptions 632 that are impacted by the value 554 and the key facts and assumptions 634 that impact the value 554 are shown, along with the amounts 636, 638 of the respective impacts. A search box 639 allows the user, from this screen, to search for other variables that may be impacted by the value 554, or those that may impact the value 554.

The opinions 652 in screen 650 may be sorted according to source, for example, the user's own opinion 654, opinions 656 reviewed, possibly edited, and sorted by an analyst employed by the entity hosting the information, and raw opinions 658 entered by other users. As with the data in other screens, these opinions 652 may include links to underlying facts or assumptions and to calculated facts or estimates that are affected by the opinions. In the example shown, opinions are listed for the estimated percentage of peak sales reached in the last year of fast sales ramp-up 554.

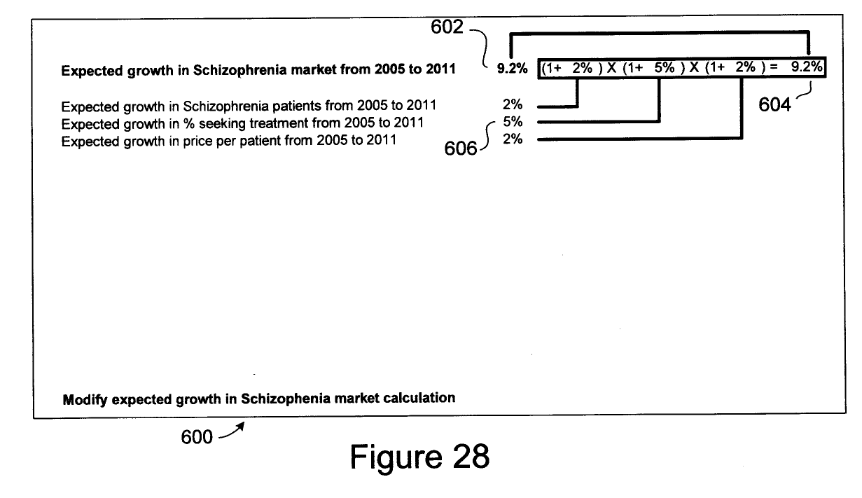

Screen 580 (FIG. 19) links to screen 600 in FIG. 28 for its expected growth input 602. Screen 600 shows the formula 604 from which the expected growth is computed and its inputs 606. Additional screens (not shown) could show the origin, use, sensitivity, and opinions about each of those inputs.

Another hierarchy of screens, related to and linked to the hierarchy just described, is shown in FIGS. 29-32. These screens display news and how that news relates to asset valuations. Screen 700, in FIG. 29, is a top-level screen showing news related to the selected asset. Standard user interface elements 702 allow the user to arrange the news by date, company part (corresponding to the hierarchies explored above), or the estimated influence on the company. For each headline 704a-n in a first column 704, the component 706a-n affected by the corresponding news is indicated in a second column 706, and the estimated influence 708a-n is listed in a third column 708. After news specific to the selected company is shown, additional news 710, in this case industry news, is shown (off the edge of the example screen 700).

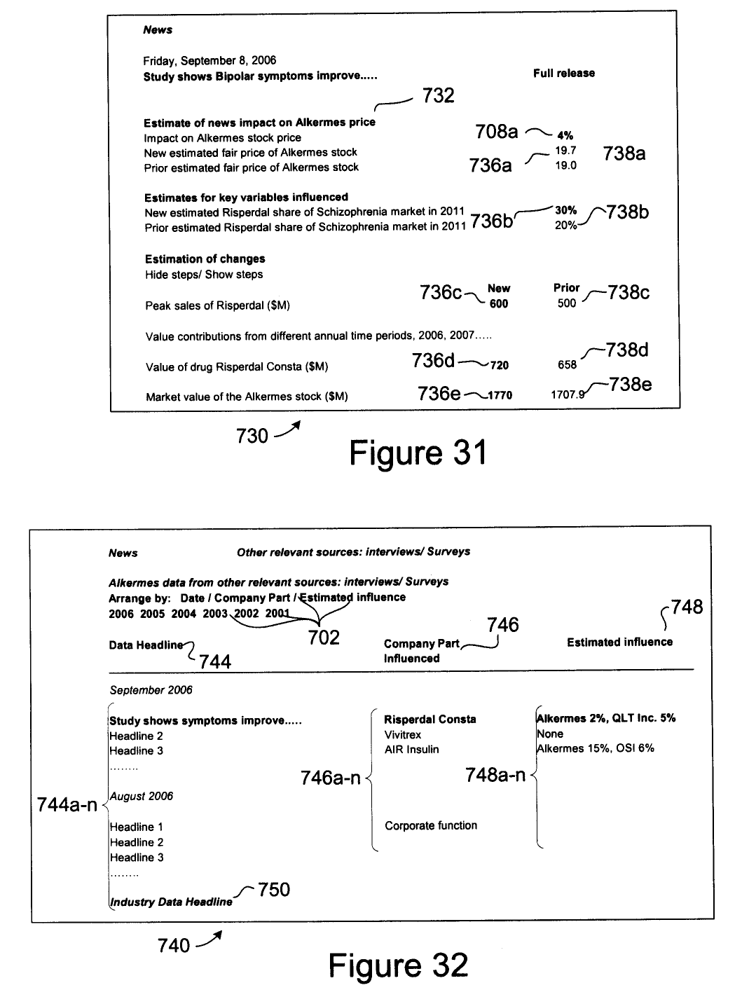

If a user selects a listed news headline 704a, he is taken to a detail screen 720 shown in FIG. 30. This screen shows the full news release 722 along-side a summary 724a and conclusions 724b written, for example, by an analyst employed by the operator of the information system. The expected influence 708a this news will have on the asset's value is repeated from the main news screen 700. Related news 726 is listed below the story. The expected influence 708a can be further broken down in a detail screen 730 shown in FIG. 31. This screen 730 lists assumptions 732 affected by the news, including the impact 708a the news has on the asset's value and a comparison of their new values 736a-e to their old ones 738a-e. Note that the new estimated share of the market 736b corresponds to the value 584 used in calculation 572 in FIG. 18. When a user positions the mouse cursor over or clicks on the computed value 736b, a pop-up menu similar to 407a appears (not shown). By selecting a ‘See Use/Modify Use’ link within the pop-up menu, the user is taken to screen 570, in FIG. 18 showing the calculation 572 that uses the computed value 736b, labeled as 584 in FIG. 18. Additional links within pop-up menus similar to 407a, revealed on rollover of mouse or clicking on the new values 736a-e and old values 738a-e, may allow users the options to view and alter other information relevant to the origin, use, sensitivity, and opinions relevant to the different values 736a-e and 738a-e.

A link 712 at the top of the main news screen 700 takes the user to other sources of information, in particular, interviews and surveys displayed in screen 740, FIG. 32. This screen resembles the main news screen 700 and has the same interface elements 702 but the information it relates is gathered first-hand by analysts, rather than collected from news sources. Thus, instead of news headlines (704 in FIG. 29) it has data headlines 744. Similarly, the company part influenced 746, estimated influence 748, and industry data headlines 750 are comparable to the features 706, 708, and 710 in screen 700.

### Contracts

As introduced above, a transparent valuation market facilitates the creation of a market for contracts on events expected to influence values of assets. A contracts market may be created by the operator 351 (FIG. 6) (e.g., host) of the transparent valuation market or it may be created and maintained by a third party 374 and operated in cooperation with the operator 351 of the transparent valuation market (we sometimes refer to the platform as a transparent valuation market).

In current markets, which trade stocks or bonds based on a company's entire value and contracts based on either the performance of such stocks and bonds or on external economic factors, both personal and professional investors with a view on a few parts of an asset or certain events relevant to an asset, are forced to trade on the entire asset. They are exposed to risks due to other factors that affect the asset value, and they may not be comfortable assuming these risks. For example, a lawyer may have an opinion on a popular ongoing lawsuit against a public company. However, on checking the value of the stock, she is reminded of other factors that she does not understand and that may influence the stock price more significantly than may the outcome of the lawsuit. She must either trade on the whole stock or stay out of the market.

Contracts for events of broad interest relating to specific asset parts can allow such a user to trade based on her views on the asset part or event, e.g., the outcome of the lawsuit. The payoffs for such contracts explicitly depends on the event, making it concrete and verifiable. A market created in a subset of contracts expected to draw the widest appeal can provide liquidity to investors interested in trading on them. In some examples, when the fifteen hundred or so most actively-traded public stocks in US are considered, at any given point of time there may be about fifty to a hundred issues that are of broadest interest to users. An opportunity to express views specifically on these issues of broadest interest may be attractive to a wide range of users and may result in popularity of such contracts among a large base of users with different financial sophistication. Contracts can be presented through the transparent valuation market, along with the transparent, interactive content relevant to the asset, as described above. A range of users will be drawn to see the key facts, assumptions, and their basis provided by the interface at the level of products, markets and events they understand and may find the contracts to be an attractive avenue for monetizing their views. This content can be explicitly connected to estimates for contracts and asset values tied to the relevant products, markets, and events.

Beyond investors, other users, including company managers, consultants, bankers, professional experts like lawyers and doctors, students, and consumers can find this platform useful. Such people are enabled to connect to products, services and events they understand best, and trade on them. In some examples, investors holding positions in an asset but uncomfortable assuming risks due to certain factors that influence it, can use the contract market to hedge that risk through contracts on fractional assets. Users who do not wish to trade can still participate, for example, using the opinion forums to express their opinions and read about other's views on the key product and on the market assumptions that drive the contract and asset value. Such users may be interested as current or potential customers of goods ultimately produced by the company at issue. In some examples, a user might come to the forums to discuss a problem he is having with a product with others familiar with the product. In the course of his research, the user may discover that it is possible to invest in the product (or, perhaps, sell such an investment short if he thinks his problem is a design defect) without betting on the entire company that manufactures it.

### Business Model

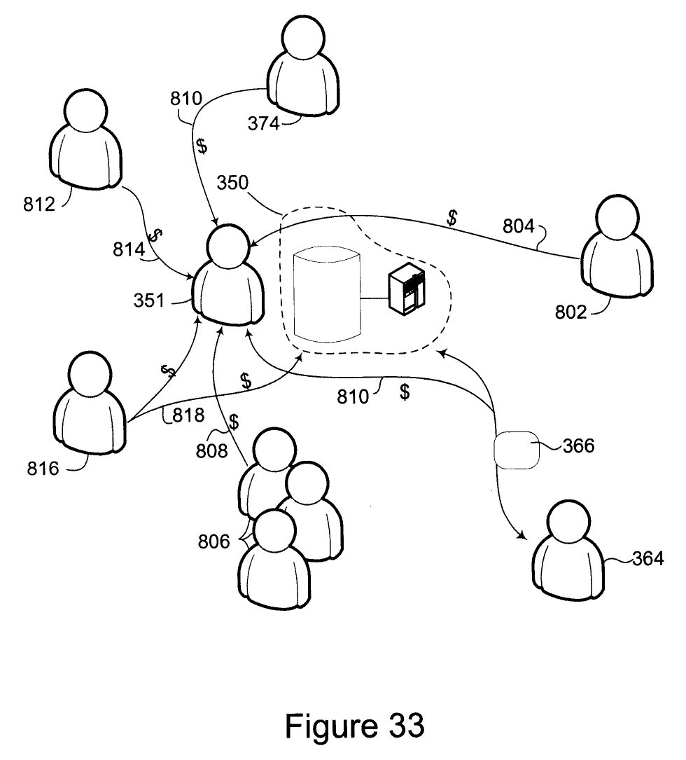

In some examples, the operator 351 of the transparent valuation market partners with more-traditional brokerages in the role of the market maker 374 to provide the contracts market. A possible arrangement of cash flows is shown in FIG. 33. The user interfaces may be integrated, so that the users don't need to be concerned with which entity they are interacting with, but the finances are separate. The operator 351 may also serve as its own market maker.

There are several possible sources of revenue for the operator 351 of the transparent valuation market 350.

Overall the US online advertising market is expected to be more than $16 Billion in 2006, and expected to reach more than $22 Billion by 2009. At a greater than 30% growth recorded in 2005, and similar growth expected in 2006, the 2009 estimate is believed to be very conservative and likely to be beaten. Increasing interest in online advertising from advertisers across industries, improved visibility and impact of online ads, and the emergence of standards have helped growth. There is also a clear understanding among advertisers that users pay more attention to online advertising than offline, a necessary part of ad efficacy.

Advertisers 802, such as marketing executives at the companies being analyzed, or their advertising agencies and representatives, will be attracted to the user traffic and activity on the transparent valuation market 350. Such advertisers will pay the operator 351 to place advertisements on the pages displayed to users 364 (revenue shown by arrow 804). With strong traffic and activity, executives 802 will want to be closely involved in placement of their ads on pages relevant to their stock and other markets they play in. For example, marketing executives 802 for a given car company will want to be closely involved with the strategy for placing ads on the different screens of the user interface relevant to their company, other car companies' stock, automobile products, and related market sections. They will want to communicate their planned product rollouts, product features, competitive comparisons, attractive sales deals, and their broader business vision to potential consumers and investors (users 364). They will see the transparent valuation market 350 as a strategic marketing resource and will use it as a channel to communicate with and target consumers and investors 364. In addition, retailers, distributors, and vendors 806 will want to advertise their products and services on the relevant product-related screens and within screens relating to relevant stocks, and thus will pay (808) for such advertising. The business strategy may involve initial or specific targeting for development of content for assets such as stocks of public companies within industries such as internet, biotechnology and others, expected to be of most popular interest.

In some examples, advertising revenues 804, 808 may be a function of user traffic on a website, average time spent per user, and CPM (cost per thousand impressions) rates. They may also be a function of popularity as judged by user traffic and time spent. The transparent valuation market 350 can attract traffic both as an alternative to other financial aggregators and directly from online brokerage websites. Strong content can encourage users 364 to spend on an average a larger amount of time on the website of the transparent valuation market 350 than on more-static sites. There is significant upside to the average time users spend on finance websites. Strong content, offered free of charge, can have a broad appeal. A combination of popular material of casual interest and unique content will engage users for a much longer time period. Unprecedented interactive features, ease of access, and transparency will support significant upside to the average time spent per user.

Due to the structured nature of information, a search performed on a term like ‘schizophrenia’ can return results that are structures at the first level in two categories: markets and science. At the next level, within each of the markets and science categories, there can be additional levels of information. For example, within the markets category, the next level of information may include the top drugs in the schizophrenia drug market, the companies that make those drugs, their current market prices, and estimates of their value and ratings. Users may view additional relevant content at other finer levels under each of these specific fields. Such structured responses to search queries that also provide information within a choice of relevant contexts can be more attractive to users than other search platforms. Similarly, advertisers may also find it more attractive to target these users within the relevant pages dealing with content for different products, markets, services, or other specific issues placed within relevant contexts of interest to them.

The average CPM pricing for display ads can vary over a wide range and depends on a number of factors. The popularity of the website, the number of users, and the amount of time they spend determines demand for the space on the page and thereby influences the price. Websites targeting niche customers can fetch higher rates. The size and format of the display can also affect price. For example, button, banner, or skyscraper ads all have different rates, where buttons are the smallest and cheapest while skyscrapers are large and more expensive per ad, but may be less on a price per unit space basis. The location on a page and of the page within a website also influence prices, e.g., homepage ads fetch more than the subsequent pages

The operator 351 of the transparent valuation market 350 may earn commission revenues 810 from investors 364 trading on their views through contracts 366 written on relevant fractional assets. The commissions 810 may be paid by the market makers 374 of those contracts 366 or directly by the users 364. The identification and underwriting of the contracts may be carried out by the market makers 374 or by the analysts or other in-house experts selected by the operator 351. The financial experts within the transparent valuation market assigned with development of the asset value estimates can be at an advantage to identify and define such contracts within assets of their responsibility. Data derived from user activity within the transparent valuation market, such as user responses to example contracts and user surveys, can be used to guide the identification and definition of contract structure and content. Such data may also be useful to understand and refine the relevance and appeal of contracts offered. The experts may work in collaboration with other experts, such as in-house or external lawyers and regulators. In some examples, identification and definition of contracts may be enabled by suggestions received from users concerning contracts of potential interest to them. Such suggestions may be received directly on the transparent valuation market platform through specific questions, surveys, or discussions on the platform. The operator may make markets itself in a subset of contracts offered, for example, to provide liquidity to the users, and may be backed by investors 812 who provide financing 814. Investors 812 may provide financing in exchange for market-making spreads earned on contracts or other forms of compensation. In some examples, the operator 351 will seek strong popularity and broadest interest in selecting contracts in which they make markets. This may be a small portion of the total market for contracts, for example, only about 5% of the overall number of assets covered, and a subset of the overall contracts offered.

Contracts can be popularized on the transparent valuation market as a naturally integrated part of the offering of transparent, hierarchically structured analysis. Through the integrated offering, the market can help individuals keep updated with news, and information, develop opinions, compare these with their own views, and express the difference in view by sharing opinions on forums or by trading in contracts. For example, if an investor disagrees with the analysis of other people investing in a contract, he may wish to buy it himself on the basis that the others are selling it for a lower price than it is worth, or vice-versa.

The transparent valuation market can also allow users to open accounts and deposit cash into those accounts so that they can directly place bids on contracts and other investment vehicles offered for investing through the market. The operator of the transparent valuation market can partner with financial institutions to be custodians of that cash and may be paid interest on the cash deposits. The operator may also be able to invest a part of that cash directly and earn revenue from such investments. Interest earned on cash in such accounts can be an important source of revenue for the operator of the transparent valuation market. A part of the interest earned can also be paid to the users directly.

There are more than 30 million US individuals with online trading accounts in the retail online trading space (based on 2005 data), trading with existing brokerage and investment firms. A partnership with online brokerage firms may attract their investors to the transparent valuation market's website. The operator of transparent valuation market can partner with one or more online brokerage firms and work closely with them to enhance the experience of users of the online brokerage firms. This can be achieved by allowing the online brokerage firms to integrate some of the content, analysis, and estimates from the transparent valuation market directly on their platform and by providing links on their platform to content within the transparent valuation markets. Additionally, the operator of the transparent valuation market may work with the online brokerage firms to issue email alerts to their users about values or price estimates for assets of interest to different users. This may help enhance familiarity and popularity and draw additional users to the transparent valuation market. Within such partnerships, users of the transparent valuation market may be able to trade on common stocks, bonds, and options through the order entry and routing platform of the partners. In addition, the partners' users may be able to trade on contracts offered by the transparent valuation market directly through their platform using the systems within the transparent valuation markets. Investors who already trade on the assets with online brokerage firms, may have strong views on the most popular asset parts and events. Contracts allowing investors to assume positions in events without assuming risk due to other factors will be attractive to these investors. Additionally, investors who want to hold positions in these assets but are uncomfortable with risks in these events will also be able to hedge against these risks through the contracts.

There are about 35 million visitors in US (includes those who do not trade online), to business and financial information websites. In addition to investors, content on the transparent valuation market will appeal to other users within this category. This includes, for example, company managers, consultants, bankers, professional experts in business, law, and medicine, consumers, and students. Partnerships with aggregator websites, including conventional media companies, can additionally be useful to drive traffic from the above category to the transparent valuation market.

Within such partnerships with other websites, the operator of the transparent valuation market may work closely with these aggregator website operators to enhance their users' experience. The user experience could be enhanced through integration of content, analyses, or estimates on their websites. In addition, the content within the transparent valuation market on estimates of impact for assets influenced by a news piece may also be integrated along side the news headline on their websites. Their real-time and historical market information on assets may also be integrated with links to relevant content for the asset and other information on the transparent valuation market. Links from financial and business information websites to the transparent valuation market can draw user traffic to the transparent valuation market. Content from transparent valuation market integrated directly on partners' websites can link back to the transparent valuation market for the convenience of users that may want to further explore the estimates or other related content.

Users may have views on products and markets they are familiar with, but not necessarily on the entire traditional investment asset underlying such products, and are commonly drawn to business and financial information, for example stock price, out of curiosity. The contracts market will attract users familiar with and directly interested in contracts. Additionally, presented as an extension to the popular news, opinion, Amazing facts, and similar sections, contracts will appeal as a natural actionable part of these sections. The easily browsed, transparent content of asset value estimates will help users refine their views on asset parts and events of interest to them. It will help them build up a comfort level they need to make the commitment to trade on contracts. As a result, visitors to business and financial information websites, who may not have views on an entire asset, and may not currently invest, will find the contracts appealing. They will find, in contracts, a unique avenue to express views on products, markets, and events they believe strongly in without being exposed to risk due to other parts of asset which they do not understand. They may also use these contracts to hedge against the specific risks due to issues on which the contracts are based.

Large or institutional investors 816 may also be a source of revenue 818 to the transparent valuation market 350 or directly to its operator 351. There are more than 8000 hedge funds and a growing number of asset management funds. Large and institutional investors may become interested as contract volumes grow and there is significant liquidity in the contract market. For example, they may be interested in contracts that help them express views in parts of an asset that they believe most strongly and in hedging their positions against undesired sources of risk. The operator of the transparent valuation market may offer exclusive services including individual analyst interaction and advice to institutional investors. They may leverage their research, analysis and transparency to build relationships with large, institutional investors.

In some examples of the system described here, the body or bodies of information are exposed to users through a publicly accessible communication medium in a manner that is non-discriminatory. By non-discriminatory, we do not necessarily focus on classic standards for non-discrimination on the basis of race, sex, religion, and the like, although, non-discrimination could include those factors. Examples of non-discriminatory access would include, at one extreme, access to anyone who can communicate through the communication medium, the access being permitted by anyone at any time for any purpose, anonymously, and without any requirement whatsoever. In less extreme examples, non-discriminatory access could permit anyone willing to register by name and with some basic demographic information to have access, or could require a modest registration fee, say $10 a month, or some other requirement. More generally, access may be viewed as non-discriminatory if potential users are not differentiated, e.g., by the host or moderator, in a way that favors access by some users as compared to others for reasons that relate to a self-interested goal of the host or moderator, for example, because of a direct and significant advantageous commercial relationship that may be anticipated by the host with some users but not with others.

In some examples of the system described here, the body of information is exposed to users on a medium and users are enabled to engage in collective discussion concerning the information elements, the collective discussion occurring on the medium in which the body is exposed. This makes it simple, easy, quick, and effective for people to engage in such discussions and for a moderator to participate in and observe the discussions and adjust the body of information based on the discussion. Examples of enabling the collective discussion to occur on the medium on which the body of information is exposed could include, for example, permitting comments to be posted directly through interactive elements of a webpage on which elements of the body of information are displayed, to have the postings viewable or accessible directly by others through interactive facilities of the webpage, or to invoke an email, chat room, or instant messaging facility directly from such a web page. More generally, any facility of a communication medium that enables users to conduct the collective discussion without having to switch to another communication medium or switch to interaction through a different application that does not have as its purpose the facilitation of the collective discussion and then to switch back to the first medium, would be included. The communication medium described in our examples could include a webpage or website, portable documents, or active online spreadsheets or documents that include direct communication and interaction capabilities, for example.

In some examples of the system described here, a moderator is enabled to participate in collective discussion by user concerning the information elements, and the moderator is enabled to do so on the medium in which the body of information is exposed. Examples of how this would be done are included above with respect to collective discussions by users. By being able to participate in such discussions on the same medium, the moderator can immediately and directly help to guide the discussion, offer suggestions, take actions, and accommodate user input in a way that enhances the transparency, intensity, and significance of the discussions.

In some examples of the system described here, all of the elements of the body of information are exposed to the users either directly or upon request. By providing access to all of the elements, users can derive a comprehensive understanding of what elements are in the body, how they relate, how they were used to generate the resulting elements, and other information about them. Although the word all suggests that every element of the body of information would be exposed to users, in some examples, all can also mean substantially all of the elements, or all of the elements that are meaningful to or useful to a particular user or a class of users. All elements might exclude elements that are experimental, or tentative, or outdated. In general, all is meant to include every element that is important or useful or expected by a user to enable the user to understand the body of information to a degree and level that gives him a high level of confidence that he fully understands any aspect of the body of information that is important to him. In particular that nothing is being withheld for some purpose other than open and transparent exposing of the body of information. For example, deliberate withholding of one or more elements until a user has entered into a direct and significant advantageous commercial relationship that may be anticipated by the host.

Other implementations are within the scope of the following claims and other claims to which the applicant may be entitled.

What is claimed is:

1. A method comprising
maintaining a body of information elements including facts, assumptions, and relationships, at least one of the information elements being a resulting element that is (a) generated from the other facts and assumptions using the relationships, and (b) representative of an estimate of a value of, or a market size of a product or service associated with, an asset,
the relationships that belong to the body of information each defining how a resulting fact or assumption that belongs to the body of information can be generated from at least one source fact or assumption that belongs to the body of information, the way in which the at least one source fact or assumption can be generated from another source fact or assumption being defined in each of multiple instances by one of the relationships that belong to the body of information, and
exposing the body of information through a publicly accessible communication medium on a non-discriminatory basis.

2. A method comprising
maintaining a body of information elements including facts, assumptions, and relationships, at least one of the information elements being a resulting element that is (a) generated from the other facts and assumptions using the relationships, and (b) representative of an estimate of a value of, or a market size of a product or service associated with, an asset,
the relationships that belong to the body of information each defining how a resulting fact or assumption that belongs to the body of information can be generated from at least one source fact or assumption that belongs to the body of information, the way in which the source fact or assumption can be generated from another source fact or assumption being defined in each of multiple instances by another one of the relationships that belongs to the body of information, and
on a medium in which the body of information is exposed to users, enabling users to engage in collective discussion concerning the information elements.

3. A method comprising
maintaining a body of information elements including facts, assumptions, and relationships, at least one of the information elements being (a) generated from the other facts and assumptions using the relationships, and (b) representative of an estimate of a value of, or a market size of a product or service associated with, an asset,
the relationships that belong to the moderated body of information each defining how a resulting fact or assumption that belongs to the body of information can be generated from at least one source fact or assumption that belongs to the body of information, the way in which the source fact or assumption can be generated from another source fact or assumption being defined in each of multiple instances by another one of the relationships that belongs to the body of information, and
on a medium in which the body of information is exposed to users, enabling a moderator to participate in collective discussion by users concerning the information elements.

4. A method comprising
maintaining a body of information elements including facts, assumptions, and relationships, at least one of the information elements being (a) generated from the other facts and assumptions using the relationships, and (b) representative of an estimate of a value of, or a market size of a product or service associated with, an asset,
the relationships that belong to the body of information each defining how a resulting fact or assumption that belongs to the body of information can be generated from at least one source fact or assumption that belongs to the body of information, the way in which the source fact or assumption can be generated from another source fact or assumption being defined in each of multiple instances by another one of the relationships that belongs to the body of information, and
through a medium in which the body of information is exposed to users, enabling users to participate financially in contracts having values that are tied to the estimated value of the asset.

5. The method of claim 4 in which the users are enabled to participate in the contracts on the medium.

6. The method of claim 5 in which the users are enabled to enter bids for the contracts on the medium.

7. The method of claim 4 also including
exposing the body of information through a publicly accessible communication medium on a non-discriminatory basis,
on the medium through which the body of information is exposed to users, enabling users to engage in collective discussion concerning the information elements, and,
on the same medium, enabling a moderator to participate in collective discussion by users concerning the information elements.

8. The method of claim 1 also including, on a medium through which the body of information is exposed to users, enabling users to engage in collective discussion concerning the information elements.

9. The method of claim 1 also including, on a medium through which the body of information is exposed to users, enabling a moderator to participate in collective discussion by users concerning the information elements.

10. The method of claim 2 also including, on the medium through which the body of information is exposed to users, enabling a moderator to participate in collective discussion by users concerning the information elements.

11. The method of claim 1 also including, on a medium through which the body of information is exposed to users, enabling users to engage in collective discussion concerning the information elements, and on the same medium, enabling a moderator to participate in collective discussion by users concerning the information elements.

12. The method of claim 1, 2, 3, or 4 also including maintaining other facts, assumptions, or relationships that are not part of the body of information, the resulting element not being generated from the other facts, assumptions, or relationships.

13. The method of claim 4 in which contracts include financial derivatives defined on events associated with an asset.

14. The method of claim 1, 2, 3, or 4 also including maintaining a controlled version of the body of information elements that is not modifiable by users except as allowed by a controlling authority.

15. The method of claim 1, 2, 3, or 4 also including enabling a user to modify a copy of at least a portion of the body of information elements.

16. The method of claim 1, 2, 3, or 4 also including enabling the user to save the modified copy.

17. The method of claim 16 including enabling a user to share the saved copy with other users on the same medium in which the body of information is exposed.

18. The method of claim 1, 2, 3, or 4 in which the medium comprises an online interactive communication medium.

19. The method of claim 18 in which the medium comprises a browser.

20. The method of claim 1, 2, 3, or 4 in which maintaining the body of information includes at least one of storing, updating, and retrieving at least a portion of the body of information on a server that is available to users through a publicly accessible communication network.

21. The method of claim 1, 2, 3, or 4 in which the body of information includes resulting elements representative of estimated values of, or a market size of a product or service associated with, more than one asset.

22. The method of claim 1, 2, 3, or 4 in which an initial body of information is generated by experts.

23. The method of claim 22 in which the experts comprise financial experts and experts in design or development of information on the communication medium working collaboratively.

24. The method of claim 23 also including providing an electronic data interface to enable interaction of the financial experts with the experts in design or development of information.

25. The method of claim 1, 2, 3, or 4 in which at least some of the facts and assumptions are received electronically from external sources.

26. The method of claim 1, 2, 3, or 4 in which at least some of the facts and assumptions are received electronically from experts.

27. The method of claim 22 in which at least one of the experts is located in a country in which expert costs are lower.

28. The method of claim 22 in which the body of information is updated by the experts over time.

29. The method of claim 28 in which the body of information is updated based on new facts and assumptions relevant to the resulting element.

30. The method of claim 1, 2, 3, or 4 in which the body of information is altered to improve the ability of users to study, discuss, and use the body of information.

31. The method of claim 30 in which the altering is done continuously as information becomes available.

32. The method of claim 30 in which the altering is done automatically in real time using electronic feeds.

33. The method of claim 30 in which the altered body of information includes archived information about the body of information prior to alteration.

34. The method of claim 23 in which the financial experts control the substance and structure of the updated body of information and the experts in the design or development of information maintain and update the implementation of the substance and structure.

35. The method of claim 22 in which the experts derive assumptions from discussions with other experts and company managers.

36. The method of claim 1, 2, 3, or 4 in which at least one of the relationships comprises a mathematical operator or mathematical relationship.

37. The method of claim 36 in which each of the relationships comprises a mathematical operator or mathematical relationship.

38. The method of claim 1, 2, 3, or 4 in which at least one of the relationships comprises a calculation in which a level of one of the facts or assumptions is used to derive a level of another of the facts or assumptions.

39. The method of claim 38 in which each of the relationships comprises a calculation in which a level of one of the facts or assumptions is used to derive a level of another of the facts or assumptions.

40. The method of claim 38 in which the levels of facts and assumptions are numerical.

41. The method of claim 1, 2, 3, or 4 in which at least some of the relationships comprise a calculation in which the sensitivity of one of the facts or assumptions is determined with respect to another of the facts or assumptions.

42. The method of claim 41 in which at least some of the relationships comprise an opinion of a user about one of the facts or assumptions.

43. The method of claim 1, 2, 3, or 4 in which one of the facts or assumptions comprises an opinion on another one of the facts or assumptions.

44. The method of claim 1, 2, 3, or 4 in which at least one of the assumptions comprises at least one of the following with respect to a company in a future time period: revenue expected to be generated in aggregate or from a product, service, or an offering associated with stock of the company; cash flow; earnings per share; or net income.

45. The method of claim 1, 2, 3, or 4 in which the resulting element comprises a possible range for the value of the asset, or of the market size of a product or service associated with an asset.

46. The method of claim 1, 2, 3, or 4 in which the resulting element comprises a possible range for expected values or expected market prices of the asset, or of the market size of a product or service associated with an asset, at a future time.

47. The method of claim 1, 2, 3, or 4 also including making an investment vehicle associated with the asset available for trading by one or more of the users, the body of information comprising an estimated value of the investment vehicle.

48. The method of claim 47 in which the asset comprises common stock of a publicly traded company.

49. The method of claim 47 in which the investment vehicle comprises a contract between a buyer and a seller based on the value of the investment vehicle.

50. The method of claim 47 in which the investment vehicle comprises a financial derivative defined on events associated with an asset.

51. The method of claim 1, 2, 3, or 4 in which the asset comprises a security.

52. The method of claim 51 in which the asset comprises stock of a company.

53. The method of claim 52 in which the asset comprises stock of a public company.

54. The method of claim 51 in which the asset comprises stock of a company that intends to raise new capital, and the body of information enables users to study an estimated value of the stock to be issued to raise the capital.

55. The method of claim 54 including enabling users to apply for ownership of at least a part of the capital by entering bids for the stock to be issued to raise the capital.

56. The method of claim 54 in which the new capital is to be raised in an Initial Public Offering (IPO).

57. The method of claim 1, 2, 3, or 4 also including enabling users to enter bids for the asset.

58. The method of claim 1, 2, 3, or 4 in which exposing the body of information includes providing an interactive navigational environment to enable the user to explore the facts, assumptions, and relationships.

59. The method of claim 1, 2, 3, or 4 in which exposing the body of information includes displaying portions of the body of information to a user.

60. The method of claim 1, 2, 3, or 4 in which exposing the body of information includes displaying a portion of less than all of the body of information and displaying a navigational element that can be invoked to have another portion of the body of information displayed.

61. The method of claim 60 in which the navigational element comprises a link representing at least one of the relationships.

62. The method of claim 60 in which more than one navigational element can be invoked with respect to a given one of the portions of the body of information.

63. The method of claim 1, 2, 3, or 4 in which the exposing includes enabling users to engage in discussions about at least some of the elements.

64. The method of claim 63 in which the discussions include proposed alterations to at least one of the facts or assumptions or relationships.

65. The method of claim 63 including barring specific users, based on their conduct, from engaging in the discussions.

66. The method of claim 63 in which the discussions are accessible to other users.

67. The method of claim 63 in which at least some of the discussions are incorporated as part of the body of information.

68. The method of claim 63 including updating the body of information based on the discussions.

69. The method of claim 63 including arranging the discussions based on an estimated skill of users with respect to the discussions.

70. The method of claim 1, 2, 3, or 4 including posting questions on topics of interest to users and enabling users to post opinions or answers in response.

71. The method of claim 70 including analyzing the user responses to derive useful information and incorporating the generated information into the body of information elements.

72. The method of claim 1, 2, 3, or 4 in which the exposing includes enabling users to understand sensitivities of facts and assumptions to changes in other facts and assumptions.

73. The method of claim 1, 2, 3, or 4 in which the exposing includes enabling users to understand sensitivities of the estimated value of the asset to facts and assumptions.

74. The method of claim 1, 2, 3, or 4 in which the exposing comprises making the body of information available to the users electronically by an electronic feed to a website host.

75. The method of claim 1, 2, 3, or 4 in which the exposing comprises displaying.

76. The method of claim 1, 2, 3, or 4 in which exposing comprises enabling a user to navigate through the relationships, facts and assumptions.

77. The method of claim 1, 2, 3, or 4 in which exposing comprises displaying portions of the body of information and providing navigational features to enable a user to study the multiple instances of relationships, the resulting facts and assumptions, the source facts and assumptions used to generate them using the relationships, and the other relationships used to generate the source facts and assumptions.

78. The method of claim 1, 2, 3, or 4 in which exposing comprises enabling users to study the facts, assumptions, and relationships, by displaying portions of the body of information, each of the portions including at least one of the resulting facts or assumptions and a navigational element that is associated with one of the relationships and, when invoked, causes display of another of the portions that includes a fact or assumption that is a source fact or assumption with respect to the resulting fact or assumption and the relationship associated with the navigational element.

79. The method of claim 78 in which in each of multiple instances, the one other portion includes (a) the source fact or assumption which is also a resulting fact or assumption and (b) an interactive navigational element that is associated with another one of the relationships and, when invoked, causes display of a third portion that includes a fact or assumption that is a source fact or assumption with respect to the source fact or assumption of the one other portion, and the relationship associated with the navigational element.

80. The method of claim 1, 2, 3, or 4 in which exposing includes exposing essentially all of the elements of the body of information that a user would need to know in order to understand how the resulting element is generated.

81. The method of claim 1, 2, 3, or 4 in which exposing includes exposing all of the elements of the body of information without withholding any.
